(19) United States
(12) Patent Application Publication
(10) Pub. No.: US 2019/0191931 A1
(43) Pub. Date: Jun. 27, 2019

(54) TOOLS FOR SHAPING A FOOD ITEM

(71) Applicant: Taco Bell Corp., Irvine, CA (US)

(72) Inventors: Armyn Hadis, Irvine, CA (US); Andrew McClellan, Walnut, CA (US); Nancy Kanis, Dana Point, CA (US); Edgar Guzman, Fontana, CA (US); Jose Mercado, Azusa, CA (US); Javier Mercado, El Monte, CA (US); Greg Iorio, San Clemente, CA (US)

(21) Appl. No.: 16/292,696

(22) Filed: Mar. 5, 2019

Related U.S. Application Data
(63) Continuation-in-part of application No. 16/114,777, filed on Aug. 28, 2018.
(60) Provisional application No. 62/553,654, filed on Sep. 1, 2017.

(51) Int. Cl. A47J 43/20; A47J 43/18; A47J 37/12

(52) U.S. Cl. CPC A47J 43/20; A47J 37/1295; A47J 43/18

(57) ABSTRACT

Systems and methods for shaping food items are provided. The systems and methods can shape the food items into taco shapes. A system can include a basket and an insert. The basket includes at least one trough and a handle. The insert includes at least one wedge. The insert is assembled with the basket in use, and frozen patties are placed in the insert and/or the basket. The insert is assembled with the basket such that the wedges and/or troughs contact the patties. The assembly is placed in hot oil to cook the patties. As the patties cook and soften, the insert moves downward relative to the basket, and the wedges and/or troughs urge the patties into the troughs and into a taco shape.

### CROSS-REFERENCE TO RELATED APPLICATIONS

Any and all applications for which a foreign or domestic priority claim is identified in the Application Data Sheet as filed with the present application are hereby incorporated by reference under 37 CFR 1.57.

In particular, this application is a continuation in part of U.S. patent application Ser. No. 16/114,777, filed Aug. 28, 2018, which claims benefit of U.S. Provisional Patent Application Ser. No. 62/553,654 filed Sep. 1, 2017, each of which is hereby incorporated by reference in its entirety.

### BACKGROUND

### Field

The present disclosure relates generally to apparatuses and methods for shaping a food item, and more particularly, to tools and methods for shaping a patty into a taco shape.

### Description of the Related Art

Various technologies and methods exist for shaping food items. For example, various devices and methods exist for forming tortillas into U-shaped hard shell tacos.

### SUMMARY

The systems and methods described herein provide for the shaping of food items or products, for example, patties made of potatoes, meat, and/or other food item(s), into taco shapes. The systems and methods described herein can advantageously include features to help align various components of the systems.

In some embodiments, an insert is configured to slidingly engage with a basket and be movable from a first position to a second position relative to the basket to change a shape of a plurality of food items from a first shape to a second shape during cooking in a fryer. The basket includes a lower trough. The lower trough defines the second shape. The insert includes a wedge and an upper trough. The upper trough is disposed below the wedge and defines the second shape. The upper trough is movable in a first direction towards the wedge and in a second direction away from the wedge. The upper trough of the insert is configured to be disposed above the lower trough of the basket at least when the insert is slidingly engaged with the basket. The upper trough is also configured to move away from the lower trough in the first direction and move towards the lower trough in the second direction when the insert is in the second position.

In some embodiments, a system is configured to change a shape of a plurality of food items from a first shape to a second shape during cooking in a fryer. The system includes a basket and an insert. The basket has a lower trough that defines the second shape. The insert is configured to slidingly engage with the basket and move from a first position to a second position relative to the basket. The insert includes a wedge and an upper trough disposed below the wedge. The wedge is closer to the lower trough of the basket when the insert is in the second position than when the insert is in the first position. The upper trough defines the second shape and is movable in a first direction towards the wedge and in a second direction towards the lower trough when the insert is in the second position.

In some embodiments, a method for changing a shape of a plurality of food items from a first shape to a second shape during cooking in a fryer includes providing a basket having a lower trough defining the second shape and providing an insert having a wedge and an upper trough. The upper trough defines the second shape. The method includes placing one of the plurality of food items in the basket above the lower trough and placing one of the plurality of food items in the insert between the wedge and the upper trough. The method also includes lowering at least a portion of the basket into the fryer so that the weight of the insert presses the wedge directly against the one of the plurality of food items in the insert and indirectly against the one of the plurality of food items in the basket to form the plurality of food items into the second shape while cooking.

In some embodiments, an apparatus is configured to change a shape of a first food item and a second food item stacked below the first food item from a first shape to a second shape during cooking in a fryer. The apparatus includes a wedge, a lower trough, and an upper trough. The wedge is configured to contact a top surface of the first food item. The lower trough is disposed below the wedge and is movable relative to the wedge. The lower trough has the second shape. The upper trough is disposed between the wedge and the lower trough and has the second shape. The upper trough is configured to separate the first food item from the second food item and contact a top surface of the second food item when the first food item and the second food item are placed in the apparatus. The upper trough is movable relative to the wedge and the lower trough when the lower trough is a fixed distance from the wedge.

In some embodiments, a system for changing a shape of a food item from a first shape to a second shape includes a tool and an insert. The tool includes a frame, two receptacles, and at least one post extending upwardly from the tool. Each receptacle is configured to receive a food item when the food item is in the first shape. The insert is configured to slidingly engage with the tool. The insert includes a frame, a guide, two wedges extending downward from the frame, and a handle. The guide of the insert is configured to receive and slide along an outer surface of the at least one post of the tool in use. Each wedge is configured to contact the food item received in one of the receptacles and urge the food item into the second shape.

In some such embodiments, the tool includes two posts and a crossbar extending between and connecting upper ends of the posts. The insert can include a locking mechanism. The locking mechanism includes a crossbar and a catch at each end of the crossbar. The crossbar and catches are pivotally coupled to the handle of the insert. As the insert is assembled with the tool in use, the crossbar and catches of the insert pivot relative to the handle to allow the crossbar and catches to slide past the crossbar of the tool. Once the crossbar and catches of the insert have cleared the crossbar of the tool, the crossbar and caches pivot back toward their original orientation and portions of the catches are disposed below the crossbar of the tool. If a user attempts to lift the insert away from the tool, the catches contact the crossbar of the tool and cause the tool to be lifted along with the insert.

In some embodiments, the insert includes two side guides. Each side guide extends outward and the downward from the frame of the insert. The side guides are configured to be received in gaps formed between the frame of the tool and the receptacles of the tool.

In some embodiments, the system further includes a basket including at least two troughs. The tool is configured to be placed on the basket such that the receptacles align with the troughs. The wedges are configured to urge each food item received in the two receptacles into the at least two troughs during cooking to shape each food item into the second shape.

In some embodiments, an insert for slidingly engaging with a basket and moving between a first position and a second position to change a shape of a food item from a first shape to a second shape during cooking in a fryer, wherein the basket includes at least one trough defining the second shape and a guide, includes a body having a channel and at least one wedge. The channel is sized and shaped to slidingly engage with the guide when the insert moves from the first position to the second position. The at least one wedge is sized and shaped to fit within the at least one trough and provide a gap between the at least one wedge and the at least one trough when the insert is in the second position. The gap has the second shape.

In some such embodiments, a system for changing the shape of a food item from a first shape to a second shape includes the insert and a tool. The tool is configured to be disposed on the basket and includes two receptacles. Each receptacle is configured to receive the food item when the food item is in the first shape. The insert is configured to slidingly engage the tool. In some embodiments, the tool includes at least one post and the insert includes a guide configured to slidingly engage the at least one post.

In some embodiments, a system for changing a shape of a food item from a first shape to a second shape during cooking in a fryer includes a basket, a tool, and an insert. The basket includes at least one trough defining the second shape and at least one peak. The basket is configured to be at least partially submerged in the fryer. The tool is configured to be disposed on the basket. The tool includes a receptacle that is configured to receive the food item when the food item is in the first shape. The insert includes a pair of channels and at least one wedge. The pair of channels are sized and shaped to slidingly engage with the at least one peak when the insert moves from a first position to a second position relative to the tool. The at least one wedge is sized and shaped to fit within the at least one trough and provide a gap between the at least one wedge and the at least one trough when the insert is in the second position such that the gap has the second shape.

In some such embodiments, the tool includes at least one upwardly extending post, and the insert includes a guide configured to slidingly receive the at least one post. In some embodiments, the tool includes a handle and the insert includes a handle. The handle of the insert is configured to engage the handle of the tool when the insert moves to the second position.

In some embodiments, a method for changing a shape of a food item from a first shape to a second shape during cooking in a fryer includes: providing a basket having at least one trough defining the second shape and at least one peak, the basket being configured to be at least partially submerged in the fryer; locating a tool having a receptacle to a position on the basket, the receptacle having the first shape; placing the food item in the receptacle; locating an insert having a pair of channels and at least one wedge above the tool so that the pair of channels are aligned with the at least one peak; lowering the insert onto the tool so that the pair of channels slidingly engage with the at least one peak until the at least one wedge rests on the food item; and lowering at least portions of the basket, the tool, and the insert into the fryer so that the pair of channels continue to slidingly engage with the at least one peak while the at least one wedge presses the food item into the at least one trough to form the second shape while cooking.

All of these embodiments are intended to be within the scope of the disclosure herein. These and other embodiments will become readily apparent to those skilled in the art from the following detailed description having reference to the attached figures, the disclosure not being limited to any particular disclosed embodiment(s).

### BRIEF DESCRIPTION OF THE DRAWINGS

These and other features, aspects, and advantages of the present disclosure are described with reference to the drawings of certain embodiments, which are intended to schematically illustrate certain embodiments and not to limit the disclosure.

FIG. 1 illustrates two example patties made of potatoes.

FIG. 2 illustrates a top perspective view of an example embodiment of a basket.

FIG. 3 illustrates a side view of the basket of FIG. 2.

FIG. 4 illustrates a top view of the basket of FIG. 2.

FIG. 5 illustrates a front end view of the basket of FIG. 2.

FIG. 6 illustrates a top perspective view of an example embodiment of a tool configured to be used with the basket of FIG. 2.

FIG. 7 illustrates a top view of the tool of FIG. 6.

FIG. 8 illustrates a side view of the tool of FIG. 6.

FIG. 9 illustrates an end view of the tool of FIG. 6.

FIG. 10 illustrates a top perspective view of an example embodiment of an insert configured to be used with the basket of FIG. 2 and the tool of FIG. 6.

FIG. 11 illustrates a side view of the insert of FIG. 10.

FIG. 12 illustrates a top view of the insert of FIG. 10.

FIG. 13 illustrates an end view of the insert of FIG. 10.

FIG. 14 illustrates an exploded perspective view of the basket of FIG. 2, the tool of FIG. 6, and the insert of FIG. 10 prior to assembly.

FIG. 15 illustrates a perspective view of the basket, tool, and insert of FIG. 14 assembled together.

FIG. 16 illustrates an end view of the assembled basket, tool, and insert of FIG. 15.

FIG. 17 illustrates a side view of the assembled basket, tool, and insert of FIG. 15.

FIG. 18 illustrates a top view of the assembled basket, tool, and insert of FIG. 15.

FIG. 19 illustrates another example embodiment of a tool assembled with a basket.

FIG. 20 illustrates the patties of FIG. 1 placed in the assembled tool and basket of FIG. 19.

FIG. 21 illustrates the patties, tool, and basket of FIG. 20 and another example embodiment of an insert assembled with the tool.

FIG. 22 is similar to FIG. 21, showing a second insert assembled with the tool.

FIG. 23 illustrates a side view of one of the patties of FIG. 1 shaped into a taco shape and filled with fillings.

FIG. 24 illustrates a top view of the taco of FIG. 23.

FIG. 25 illustrates a top perspective view of another example embodiment of a basket.

FIG. 26 illustrates a side view of the basket of FIG. 25.

FIG. 27 illustrates a top view of the basket of FIG. 25.

FIG. 28 illustrates a front view of the basket of FIG. 25.

FIG. 29 illustrates a top perspective view of an example embodiment of an insert configured to be used with the basket of FIG. 25.

FIG. 30 illustrates a side view of the insert of FIG. 29.

FIG. 31 illustrates a top view of the insert of FIG. 29.

FIG. 32 illustrates a front view of the insert of FIG. 29.

FIG. 33 illustrates the insert of FIG. 29 aligned vertically above the basket of FIG. 25 prior to being assembled together.

FIG. 34 is similar to FIG. 33 except that the insert of FIG. 29 has been lowered onto the basket of FIG. 25.

FIG. 35 illustrates a perspective view of the basket of FIG. 25, insert of FIG. 29, and a plurality of patties prior to submerging at least a portion of the basket and insert assembly into a fryer.

FIG. 36 illustrates a front view of the basket of FIG. 25 and the insert of FIG. 29 assembled together.

FIG. 37 is similar to FIG. 36 except that the movable portion of the insert of FIG. 29 has been raised relative to the rest of the assembly.

FIG. 38 is a cross sectional view of the basket of FIG. 25 and the insert of FIG. 29 assembled together with a plurality of uncooked patties.

FIG. 39 is similar to FIG. 38 except that the insert of FIG. 29 has been lowered further onto the basket of FIG. 25 and the patties have been cooked and shaped.

### DETAILED DESCRIPTION

Although certain embodiments and examples are described below, those of skill in the art will appreciate that the disclosure extends beyond the specifically disclosed embodiments and/or uses and obvious modifications and equivalents thereof. Thus, it is intended that the scope of the disclosure herein disclosed should not be limited by any particular embodiments described below.

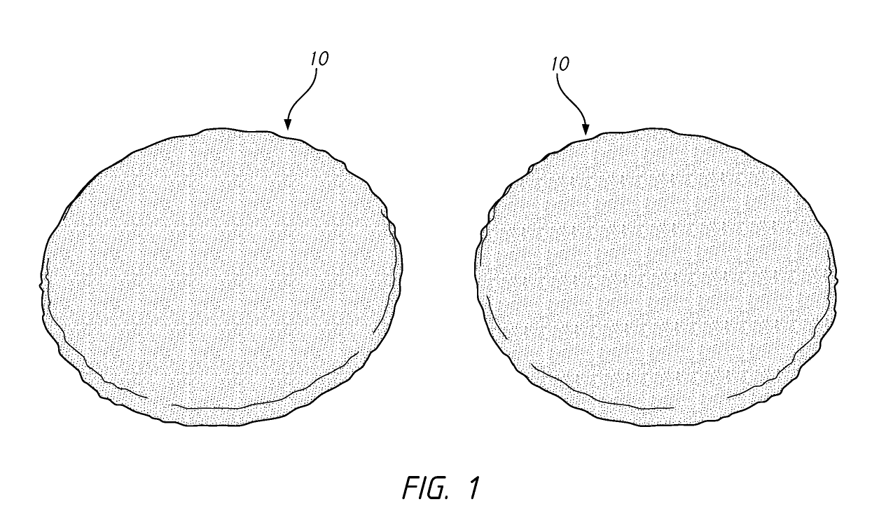

The systems and methods described herein can be used to change the shape of a food item from a first shape to a second shape. For example, the systems and methods described herein can be used to shape a food item into a desired shape, such as a taco shape. The food item can be a patty 10 made of or including, for example, potatoes, various meat, such as chicken or beef, which may be breaded or unbreaded, or another food item. The patty 10 can be round or circular, for example, as shown in FIG. 1. The patty 10 can be another shape, such as square, rectangular, or oval. In some embodiments, the patty 10 is frozen, or otherwise rigid or relatively rigid, before being placed in the systems described herein for cooking and shaping. In some embodiments, the food item is fresh or not frozen before being placed in the systems described herein for cooking and shaping.

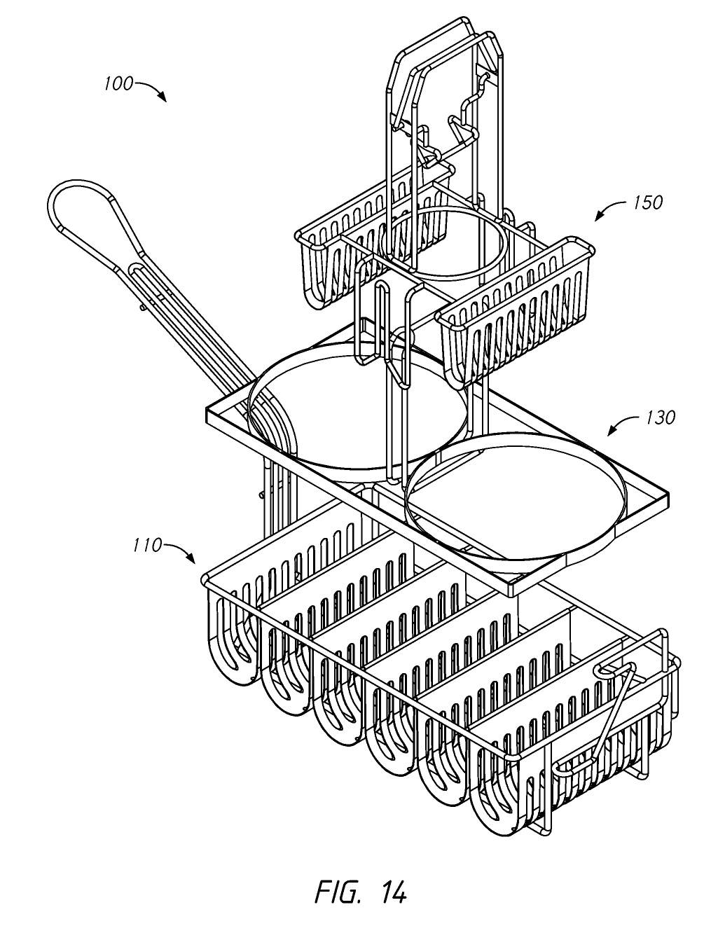

In some embodiments, a system 100 for shaping a food item, such as a patty 10, includes a basket 110, a tool 130, and an insert 150. In some embodiments, the basket 110 and the tool 130 are integral and/or the basket 110 includes at least some features of the tool 130, such as a plurality of posts 136. In some embodiments, the insert 150 and the tool 130 are integral and/or the insert 150 includes at least some features of the tool 130. An exploded view of an example embodiment of a system 100 for shaping a food item is shown in FIG. 14. The basket 110, tool 130, and/or insert 150 can be made of metal. In some embodiments, the basket 110, tool 130, and/or insert 150 can be made of plastic. The basket 110, tool 130, and/or insert 150 can be made of a material that is food-safe and suitable for use in high temperatures, such as in a fryer, oven, or microwave.

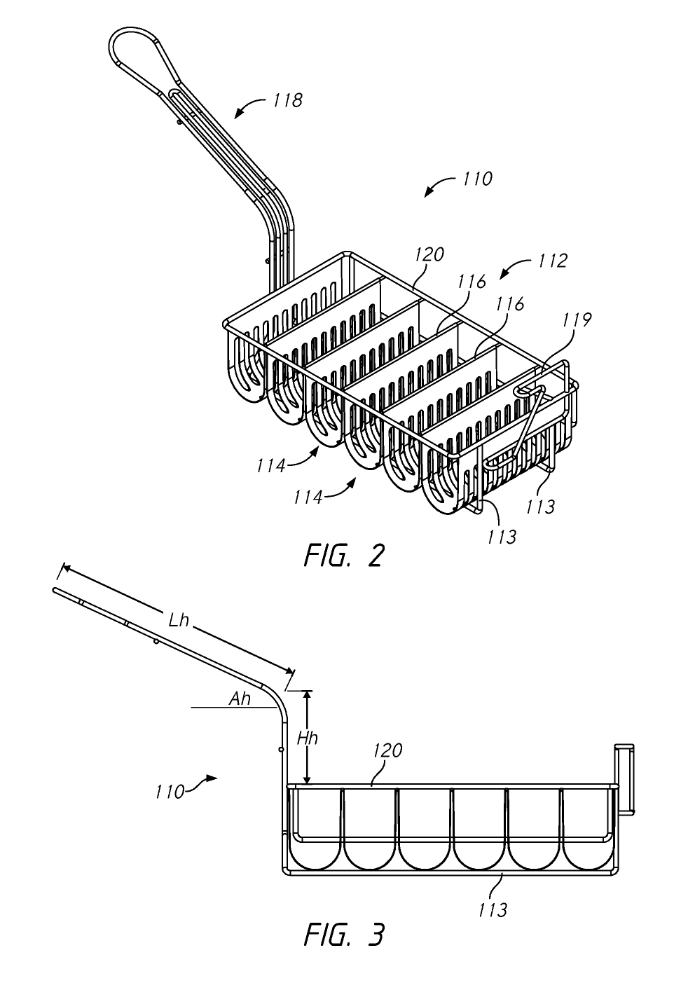

An example embodiment of a basket 110 is shown in FIGS. 2-5. The basket 110 includes a base 112 having a frame 120 and at least one trough 114. The frame 120, can be rectangular as shown. The illustrated embodiment includes six troughs, but more or fewer troughs 114 are also possible. Each trough 114 is at least partially defined by two peaks 116, one on each side of the trough 114. In embodiments having a plurality of troughs 114, one or more of the peaks 116 may each separate and/or at least partially define two adjacent troughs 114. The peaks 116 can extend between and be connected to the frame 120 of the base 112 as shown. The outermost peaks 116 at the ends of the base 112 extend along or are defined by ends of the frame 120. The basket 110 can include one or more support bars 113 extending lengthwise along a bottom of the basket 110 beneath the troughs 114. In the illustrated embodiment, the basket 110 includes a handle 118 extending from one side or end of the base 112. The basket 110 may include a hook 119 that contacts or engages a fryer during use. In the illustrated embodiment, the basket 110 includes a hook 119 that extends from an opposite end of the base 112 from the handle 118.

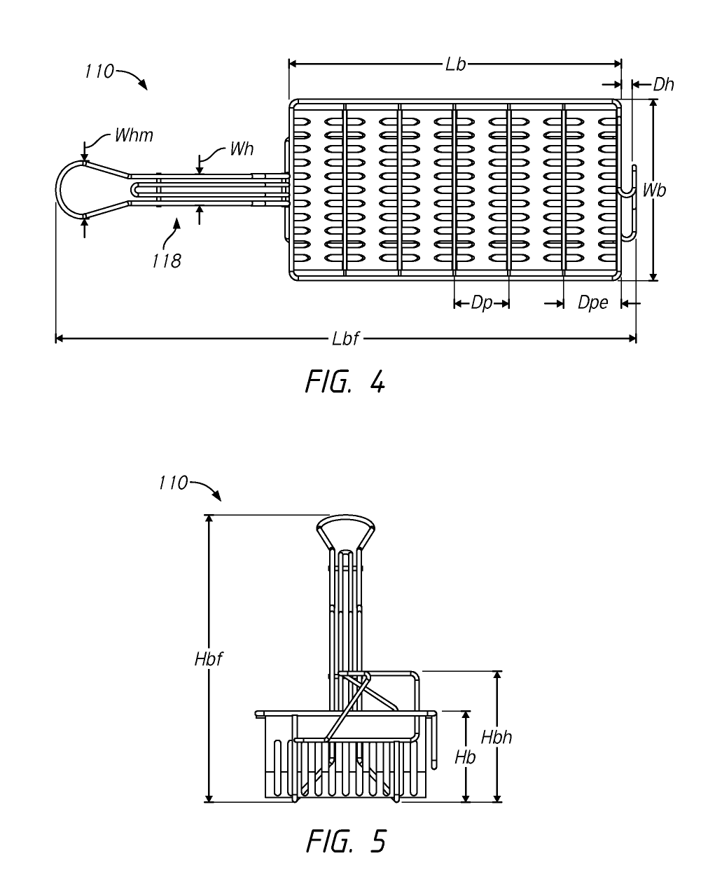

In some embodiments, a length Lb (shown in FIG. 4) of the frame 120 of the basket 110 is about 12½ inches and a width Wb of the frame 120 is about 6¾ inches. Adjacent peaks 116 can be separated by a distance Dp of about 2 inches such that the troughs 114 have a width of about 2 inches. The two troughs 114 adjacent the ends of the frame 120 can have a width Dpe of about 2 3/16 inches. The handle 118 can extend upward from the body 112 by a distance Hh (shown in FIG. 3) of about 3¼ inches, then extend a length Lh of about 8½ inches at an angle Ah of about 25° upward from horizontal. In some embodiments, a body of the handle 118 has a width Wh of about 1¼ inches. An enlarged distal portion of the handle 118 (positioned away from the body 112) may have a width Whm at its widest point of about 1⅞ inches. In embodiments including a hook 119, the hook 119 may extend a distance Dh of about 5/16 inch from an end of the frame 120. A full length Lbf of the basket 110 including the handle 118 and the hook 119 can be about 21 5/16 inches. A height Hb (shown in FIG. 5) of the base 112 including the support bars 113 can be about 3½ inches. A height Hbh of the base 112 including the support bars 113 and hook 119 can be about 5 inches. A full height Hbf of the basket 110 including the handle 118 and the support bars 113 can be about 9½ inches. In some embodiments, the basket 110 can have a weight of about 2-3 pounds. For example, the basket 110 can have a weight of about 2 pounds, 4.7 ounces.

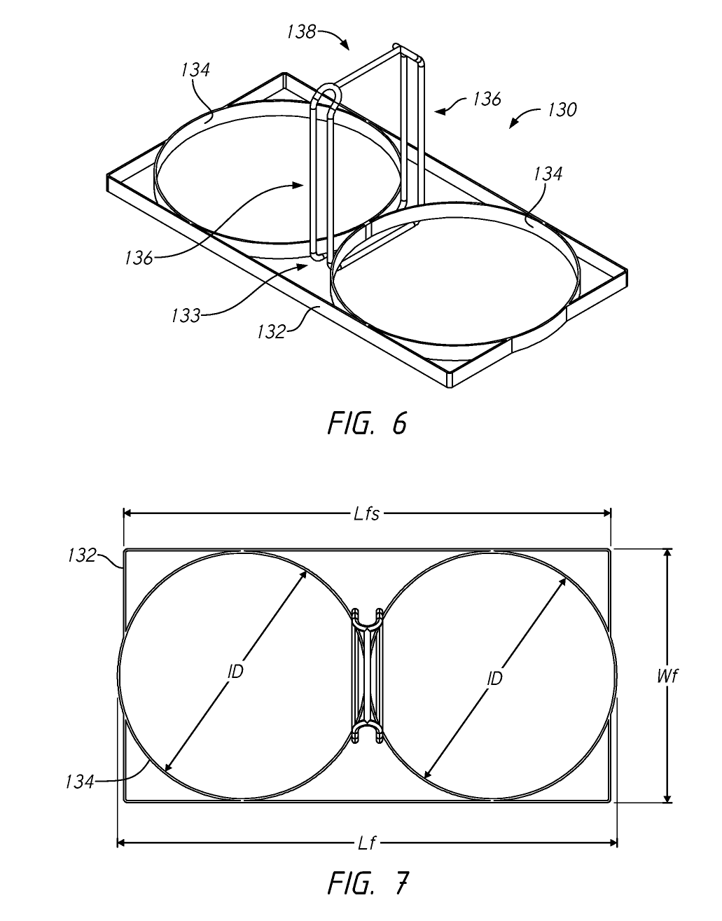

FIGS. 6-9 illustrate an example embodiment of a tool, which can act as a patty alignment and/or centering tool in certain embodiments, 130. In other embodiments, the tool 130 aligns foods other than a patty. In some embodiments, the assembly does not include the tool 130. In some embodiments, other components in the system 100 include at least some of the features of the tool 130, such as posts 136. In some embodiments, the tool 130 includes two receptacles 134. The receptacles 134 are sized and shaped to receive the food item. For example, the receptacles 134 can be circular as shown to receive circular or generally circular patties 10. Alternatively, the receptacles 134 can be another shape, such as square, rectangular, or oval, to receive other shaped patties 10 or foods. In some embodiments, receptacles 134 are not included and the patties 10 can be placed directly on other components in the system 100, such as above troughs 114. The illustrated circular receptacles 134 meet (e.g., are in contact or near contact with each other) in the center of the tool 130. In the illustrated embodiment, the tool 130 includes a generally rectangular frame 132 surrounding, partially bordering, and/or supporting the two receptacles 134. In the illustrated embodiment, mid portions of the ends of the frame 132 are formed by or curved to accommodate the receptacles 134 such that mid portions of the ends of the frame 132 are curved outwardly. The frame 132 is sized and shaped to at least partially nest or fit with the frame 120 of the base 112 of the basket 110. The tool 130 also includes two upwardly extending posts 136. The posts 136 are positioned centrally along the length of the tool 130 with one disposed on each side of a central longitudinal axis of the tool 130 (e.g., an axis extending parallel to the long sides of the rectangular frame 132 and extending through centers or midpoints of the short sides of the rectangular frame 132). Each post 136 extends upward from and/or through a gap 133 formed between an inner surface of a central portion of a side of the frame 132 and outer surfaces of the two circular receptacles 134. The posts 136 can be coupled or secured to the receptacles 134. A cross-bar 138 extends between and connects upper or top ends of the two posts 136. In some embodiments, the cross-bar 138 can be used as a handle. In the illustrated embodiment, each post 136 includes two parallel wires joined by a U-shaped portion at the top or upper end of the post 136 or a single wire formed in a U-shape such that the curved portion of the U-shape is positioned at the top or upper end of the post 136 and the parallel arms extend downward toward the receptacles 134. The wire(s) forming the posts 136 may also connect to each other at bottom or lower ends of the posts 136 beneath the receptacles 134 as shown in FIG. 9.

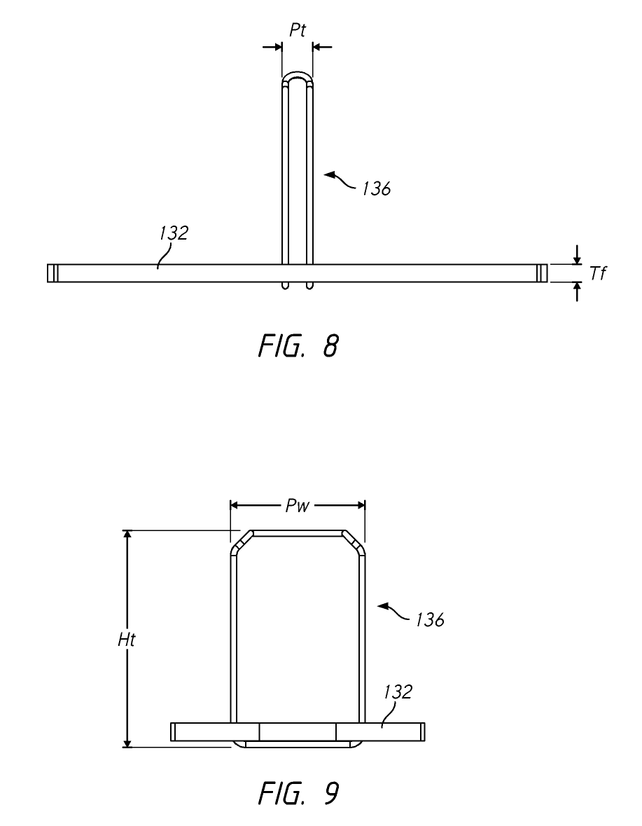

The tool 130 is shaped and sized to be placed on and/or nest with the basket 110. The frame 132 can have a width Wf (shown in FIG. 7) of about 6¼ inches. The sides of the frame 132 can have a length Lfs of about 12 inches. The frame 132 can have a total length Lf including curved mid portions of the ends of the frame 132 of about 12¼ inches. The frame can have a height or thickness Tf (shown in FIG. 8) of about 7/16 inch. The receptacles 134 can have inner diameters ID of about 6 inches. A total height Ht (shown in FIG. 9) of the tool 130 can be about 5⅜ inches. The posts 136 can span a distance Pw of about 3 5/16 inches across the width of the frame 132. Each post 136 can have a thickness Pt (measured along the length of the frame 132) of about 13/16 inch. In some embodiments, the tool 130 has a weight of about 0.5-1 pound. For example, the tool 130 can have a weight of about 11 ounces.

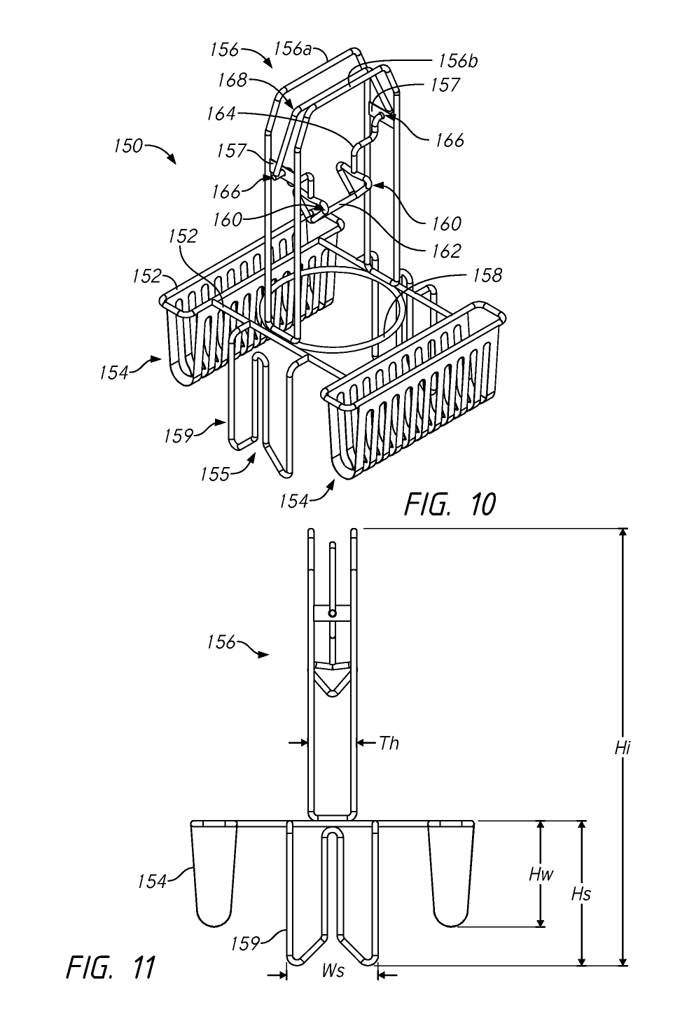

An example embodiment of an insert 150 is shown in FIGS. 10-13. The insert 150 includes a frame 152, two wedges 154, and a handle 156. One of the wedges 154 extends downwardly from each end of the frame 152. As shown, the frame 152 can include and/or form an upper perimeter of each wedge 154. The handle 156 extends upwardly from or adjacent to sides of the frame 152. As shown, the handle 156 can include a first bar 156a and a second bar 156b. The second bar 156b is spaced from the first bar 156a along a length of the insert 150. Each bar 156a, 156b extends across a width of the insert 150. The insert 150 includes a guide 158 positioned between the sides of the frame 152. In the illustrated embodiment, the guide 158 is circular, although other shapes are also possible.

In some embodiments, side guides 159 extend downward from each side of the frame 152. In the illustrated embodiment, the side guides 159 extend outward from the sides of the frame 152 then downward. Each side guide 159 includes a slot or channel 155 extending upwardly from a bottom end of the side guide 159. The cross-section shape of the channel 155 can change along the length of the channel 155. For example, in the illustrated embodiment, an opening or distal end of the channel 155 is wider than a remainder of the channel 155. The channel 155 can taper from the opening to the narrower remainder of the channel 155. As shown in FIG. 11, the side guides 159 can extend further downward or away from the frame 152 than the wedges 154.

The insert 150 is designed to slidingly engage the tool 130 and/or the basket 110 in use. The insert 150 can include one or more features designed to slidingly engage and/or align with one or more corresponding features of the tool 130 and/or the basket 110. For example, the guide 158 can align with and slidingly engage the posts 136 of the tool 130 as described in greater detail herein. Alternatively or in addition, the side guides 159 can align with and slidingly engage a peak 116 of the basket 110 as described in greater detail herein.

The insert 150 can also include a lock mechanism. The lock mechanism includes a cross bar 162 extending along the direction of the width of the insert 150. Each end of the cross bar 162 is coupled to a catch 160. In the illustrated embodiment, the catches 160 are triangular, with one corner pointing downward and coupled to the cross bar 162, and one side forming a top surface of the catch 160. A sidearm 164 extends between the top surface of each catch 160 and the handle 156. In the illustrated embodiment, each side of the handle 156 includes a side bar 157 extending between and coupling the first bar 156a and the second bar 156b of the handle 156. Each sidearm 164 is pivotally coupled to one of the side bars 157 at a pivot point 166. The sidearms 164 extend to inner facing surfaces of the side bars 157. In the illustrated embodiment, a pivot arm 168 extends from an outer facing surface of one side bar 157 across a width of the insert 150 (e.g., along a direction parallel to the handle 156) to an outer facing surface of the other side bar 157. In some embodiments, the pivot arm 168 is coupled to or integrally formed with the sidearms 164 such that the pivot arm 168 and sidearm 164 combination extends through the side bars 157 and is pivotal relative to the side bars 157. Movement of the pivot arm 168 can therefore be coupled to movement of the sidearms 164. Movement, e.g., pivoting, of the pivot arm 168 toward one end of the insert 150 causes the sidearms 164, catches 160, and cross bar 162 to move, e.g., pivot, toward the opposite end of the insert 150. Similarly, movement, e.g., pivoting, of the cross bar 162, catches 160, and sidearms 164 toward one end of the insert 150 causes the pivot arm 168 to move, e.g., pivot, toward the opposite end of the insert 150.

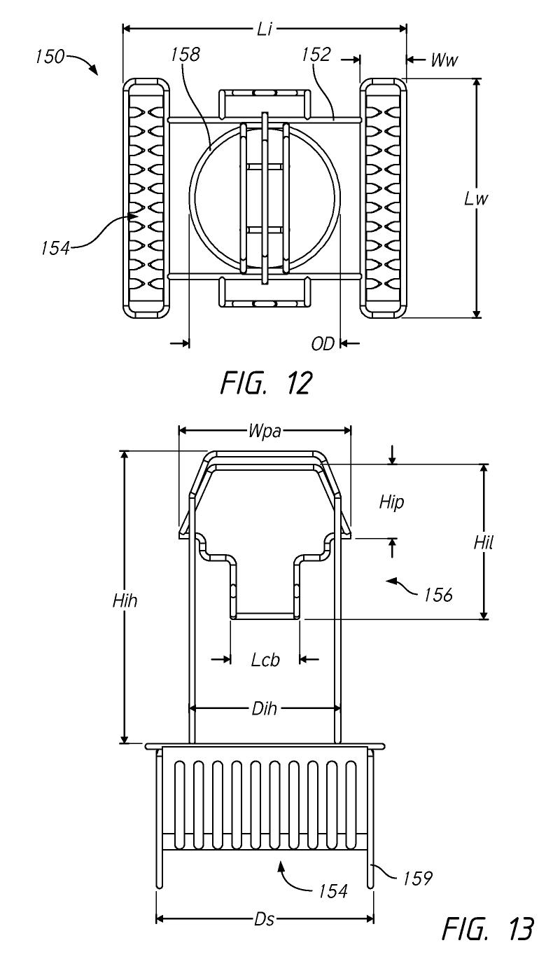

In some embodiments, the insert 150 is sized and shaped to be assembled with the tool 130 and basket 110. In some embodiments, the insert is sized and shaped to be assembled with the basket 110, without the tool 130. The frame 152 can have a total length Li (shown in FIG. 12) of about 7 5/16 inches. The portions of the frame 152 forming the tops of the wedges 154 can have lengths Lw of about 6 3/16 inches and widths Ww of about 1¼ inches. The guide 158 can have an outer diameter OD of about 3¾ inches. The wedges 154 can extend downward from the frame 152 by a distance Hw (shown in FIG. 11) of about 3⅛. The side guides 155 can extend downward from the frame 152 by a distance Hs of about 3¾ inches. The side guides 159 can have a width Ws of about 2¾ inches. The side guides 159 can span a distance Ds (shown in FIG. 13) across the width of the frame 152 of about 5⅝ inches. The handle 156 can have a thickness (measured along the length of the insert 150) Th of about 1 5/16 inches. The handle 156 can have a height Hih of about 7½ inches. The handle 156 can span a distance Dih across the width of the insert 150 of about 4 inches. The crossbar 162 can have a length Lcb of about 1⅞ inches. A height Hil measured from the pivot arm 168 to the crossbar 162 can be about 3⅞ inches. A height Hip measured from the pivot arm 168 to the pivot point 166 can be about 1¾ inches. A width Wpa of the pivot arm 168 at its widest point, e.g., measured along a line extending through both pivot points, 166 can be about 4 5/16 inches. The insert 150 can have a total height Hi of about 11¼ inches. The wedges 154 and troughs 114 are sized and shaped such that when the insert 150 is fully assembled with the tool 130 and basket 110 as described herein, the wedges 154 are received in the troughs 114, and a gap is formed between each wedge 154 and its respective trough 114. The gap forms the second shape or final desired shape of the food item, e.g., a taco shape in the illustrated embodiment.

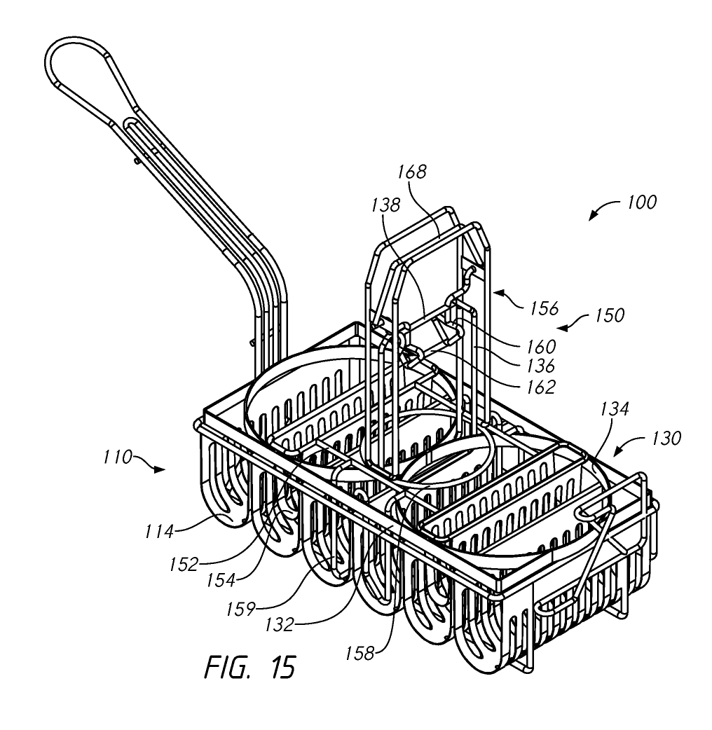

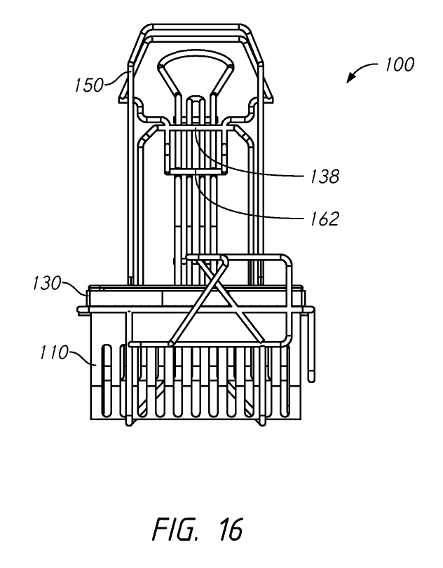

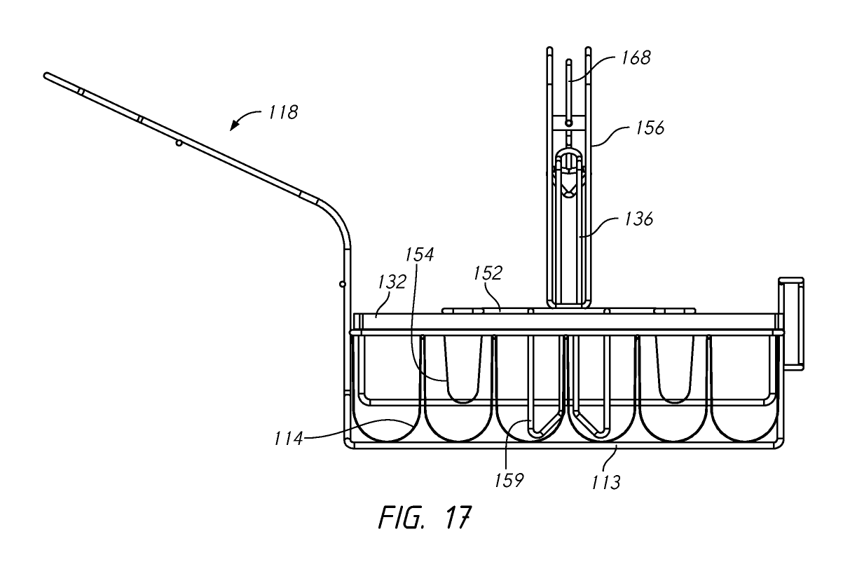

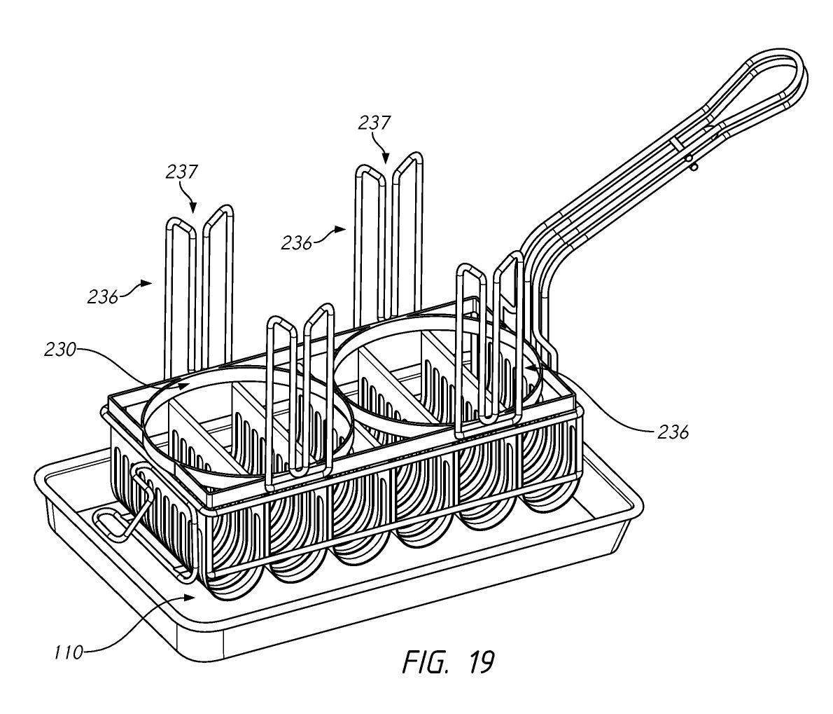

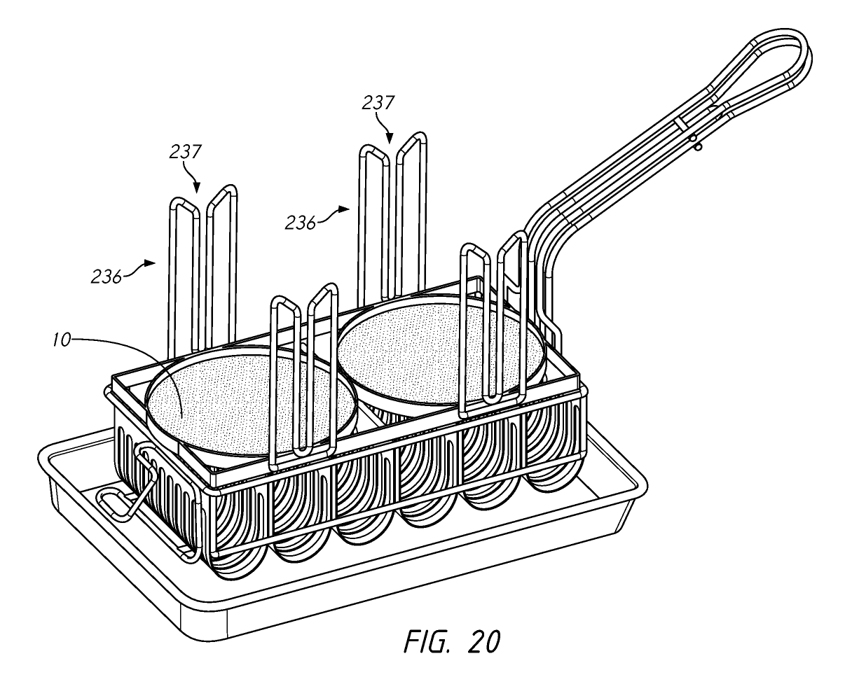

In use, the tool 130 is placed on or partially nested in the basket 110 such that a central portion of each receptacle 134 is aligned with one of the troughs 114 of the basket 110, for example as shown in FIGS. 15-18 and in FIG. 19, which shows an alternative embodiment of the tool 130. The frame 132 and receptacles 134 rest on and are supported by the peaks 116 of the basket 110. A patty 10 is placed within one or each receptacle 134 (as shown in FIG. 20, which shows the alternative embodiment of the tool 130 of FIG. 19). As discussed above, the patties 10 can be provided frozen such that the patties 10 initially maintain their shape, e.g., round shape. The insert 150 is then guided onto the tool 130. The guide 158 of the insert 150 aligns with and slides along outer surfaces of the posts 136 of the tool 130 to help properly align the insert 150 relative to the tool 130 and/or basket 110 as shown in FIG. 15. As the insert 150 is guided onto the tool 130, the channels 155 align with and at least partially engage one of the peaks 116 (e.g., the central peak 116) to help properly align the insert 150 relative to the basket 110. Because the side guides 159 extend farther downward from the frame 152 than the wedges 154, the channels 155 engage the peak 116 before the wedges 154 contact the patties 10 disposed in the receptacles 134. As the insert 150 is advanced downward relative to the tool 130, one of the wedges 154 contacts each of the patties 10 disposed in the receptacles 134.

The assembled basket 110, tool 130, and insert 150 with patties 10 are placed in a cooking apparatus to cook the patties 10. For example, the assembled basket 110, tool 130, and insert 150 with patties 10 can be placed in a fryer containing hot oil. Alternatively, the basket 110, tool 130, and insert 150 with patties 10 can be placed in an oven or microwave. As the patties 10 cook and soften, the weight of the insert 150 causes the wedges 154 to push the patties 10 into the troughs 114 with which the receptacles 134 are aligned and shape the patties 10 into a taco shape. When the insert 150 is fully seated in or advanced relative to the tool 130 and basket 110 (in other words, when the insert 150 has moved from a first position in which the insert 150 initially engages the tool 130 and a second position in which the insert 150 has been fully advanced downward relative to the tool 130), the wedges 154 are received in the troughs 114 and each patty 10 is formed into the second shape defined by the gap between the wedge 154 and trough 114. The insert 150 can be designed and manufactured to have a weight selected to promote a required or desired rate of the wedges 154 pushing the patties 10 into the troughs 114. The required or desired rate of the wedges 154 pushing the patties 10 into the troughs 114 and weight of the insert 150 can be selected considering the effect of gravity. For example, if the insert 150 is too light and the wedges 154 do not apply enough weight or force to the patties 10, the patties may cook without being forced into the troughs 114 and formed in the desired shape. On the other hand, if the insert 150 is too heavy and the wedges 154 force the patties 10 into the troughs 114 too quickly, the patties 10 may crack as they cook. In some embodiments, the insert 150 is designed and manufactured to have an overall weight of about 1 pound. For example, the insert 150 can have a weight of about 1 pound, 4.2 ounces. A weight of about 1 pound may be appropriate for patties 10 made of, for example, potatoes or chicken. In other embodiments, the insert 150 can have a different weight. The weight of the insert 150 can be selected based on various factors, including, for example, one or more of: the food composition of the patties 10, whether the patties 10 are frozen, the weight of the patties 10, the thickness of the patties 10, and the rigidity of the patties 10. In some embodiments, the weight of the insert 150 is adjustable. In some embodiments, multiple inserts 150 having varying weights can be provided, and a user can select the appropriate insert 150. Such multiple inserts 150 can be identified or distinguished from one another via various markings or indicia, for example, differently colored handles. In some embodiments, the basket 110, the tool 130, and/or the insert 150 can include a mechanism, e.g., a removably attachable mechanism, to alter the rate of movement of the insert 150 relative to the basket 110. For example, if a faster rate of movement was desired, a spring could be attached to the basket 110. The spring could be stretched and attached to the insert 150. As the spring returned to its unstretched state, the spring would pull the insert 150 down more quickly than it might otherwise travel.

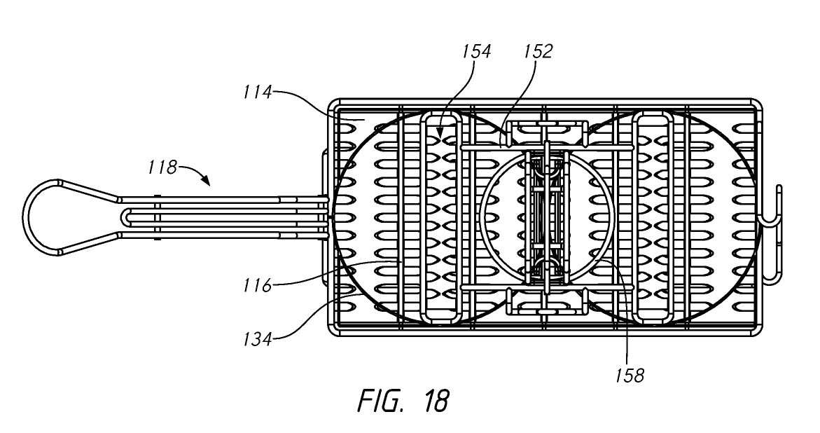

During assembly of the system, each side guide 159 slides into one of the gaps 133 as shown in FIGS. 15 and 18. The slots 155 receive one of the peaks 116 (e.g., the central peak 116 in the illustrated embodiment) and allow the side guides 159 to slide along and/or into the two troughs 114 adjacent the peak 116 received in the channel 155. Because the side guides 159 extend further downward or away from the frame 152 than the wedges 154, the side guides 159 can align with and/or engage the basket 110 prior to cooking and shaping of the patties 10. The side guides 159 can advantageously help properly align the insert 150 relative to the tool 130 and/or basket 110 and/or help secure the insert 150 to the tool 130 and/or basket 110 during use. As the patties 10 cook and the insert 150 slides downward relative to the tool 130, the side guides 159 can help maintain balance of the insert 150 and alignment of the insert 150 relative to the tool 130 and/or basket 110. For example, if two patties 10 are being cooked, if one patty 10 is larger and/or heavier than the other, one of the patties 10 may be shaped more quickly and easily than the other, and the wedges 154 may not advance into the troughs 114 evenly or simultaneously if not otherwise constrained. The insert 150 could therefore become askew and misaligned relative to the tool 130 and/or basket 110. The side guides 159 help inhibit such imbalance or misalignment of the insert 150 as movement of the insert 150 relative to the tool 130 and/or basket 110 is constrained by mating of the peak 116 with the channel 155.

As the insert 150 is advanced onto the tool 130 and basket 110 during cooking, the crossbar 162 of the locking mechanism of the insert 150 contacts the cross bar 138 of the tool 130. The crossbar 162, catches 160, and sidearms 164 can then pivot (in either direction) about pivot points 166 so that the crossbar 162, catches 160, and/or sidearms 164 can slide past the crossbar 138. The crossbar 162, catches 160, and sidearms 164 can also or alternatively be manually pivoted by the user via the pivot arm 168. The crossbar 162 of the insert 150 is shorter than the crossbar 138 of the tool 130 such that the catches 160 also contact and slide past the crossbar 138. The sloped sides of the triangular catches 160 can help the catches 160 slide past the crossbar 138. Once the crossbar 162 and catches 160 have cleared the crossbar 138, the crossbar 162, catches 160, and sidearms 164 pivot about the pivot points 166 back toward a central vertical position. Portions of the upper surfaces of the catches 160 are then disposed below the crossbar 138 of the tool 130 as shown in FIGS. 15-18. If a user pulls the insert 150 upward relative to and away from the tool 130 and basket 110, the upper surfaces of the catches 160 contact the crossbar 138 of the tool 130 so that the tool 130 is also pulled upward and away from the basket 110 with the insert 150. The locking mechanism therefore helps inhibit the insert 150 from being separated from or removed from the basket 110 separately from the tool 130. The locking mechanism can serve as a safety mechanism and/or can help promote ease of use such that the insert 150 and tool 130 can be more easily removed together from the basket 110 when desired or required.

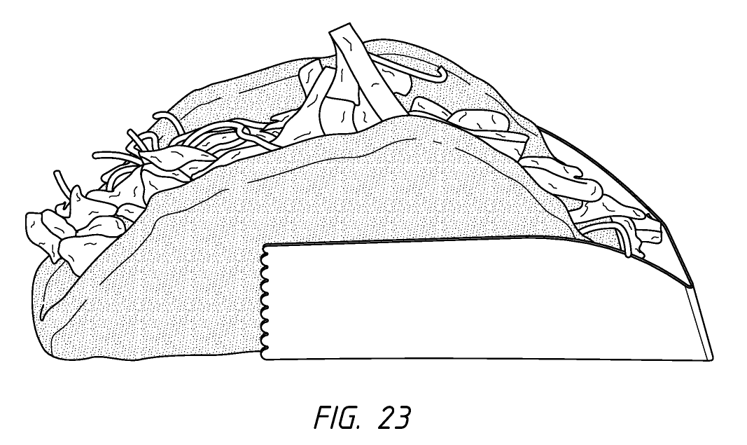

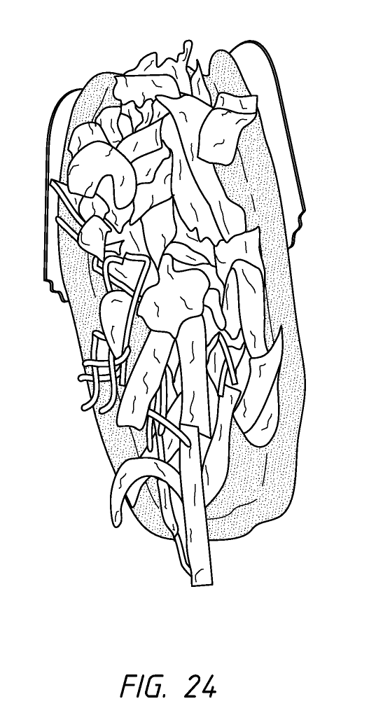

Once an appropriate cooking time has elapsed, the assembly is removed from the oil, the insert 150 and tool 130 are removed from the basket 110 (before or after removing the assembly from the oil), and the now cooked and shaped patties 10 are removed from the basket 110. The cooked and taco shaped patties 10 can be filled with various fillings, as shown in FIGS. 23 and 24.

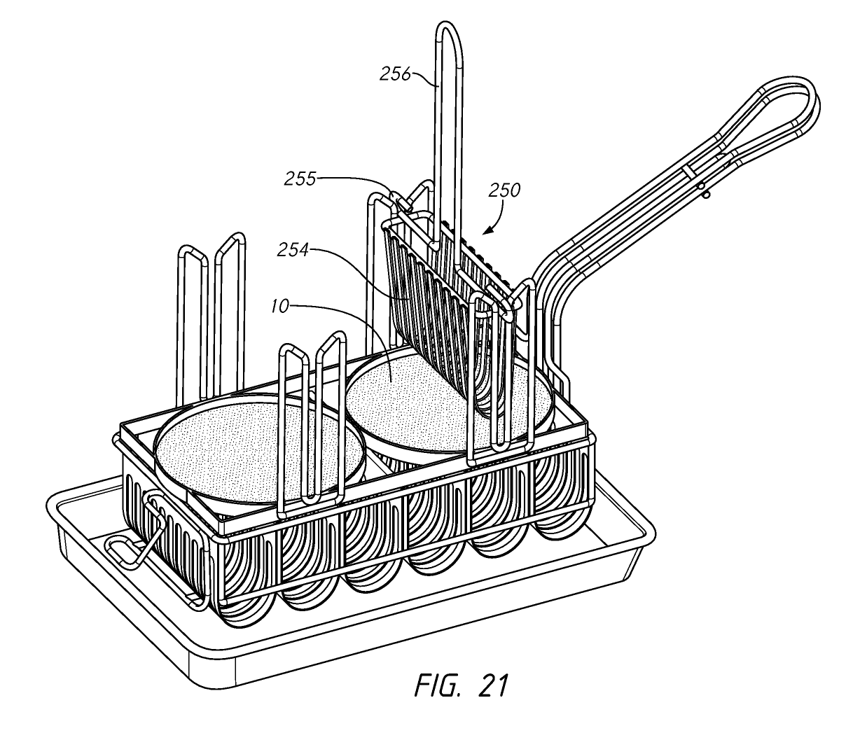

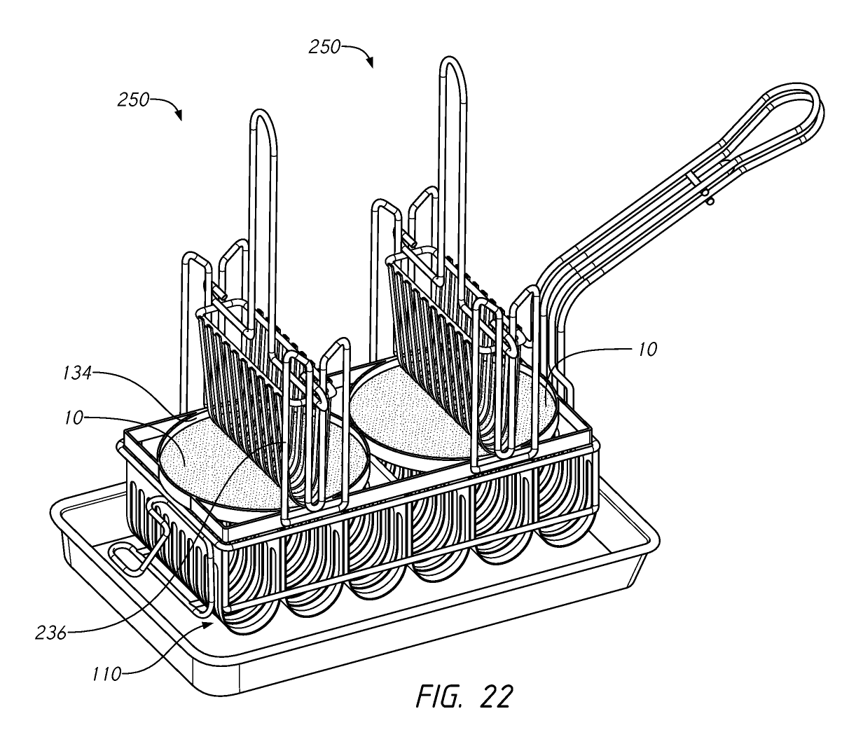

FIGS. 19-22 illustrate alternative embodiments of the tool 230 and insert 250. In this embodiment, rather than the centrally located posts 136 of tool 130, tool 230 includes four posts 236. Two posts 236 are located along each side of the tool 230, with one positioned adjacent each receptacle 134. Therefore, each receptacle 134 is positioned between two opposing posts 236. Each post 236 includes a slot 237 extending downwardly from a top of the post 236. As shown in FIGS. 21-22, the insert 250 of this embodiment includes a wedge 254 and a handle 256 extending upwardly from the wedge 254. The insert 250 can also include an alignment projection 255 extending outwardly from each end of the wedge 254. The wedge 254 is sized to slide between two opposing posts 236 to contact the patty 10 disposed in the receptacle 134 as shown in FIG. 21. The alignment projections 255 slide within the slots 237 of the opposing posts 236 to help properly align the wedge 254 with the patty 10 and basket 110. As shown in FIG. 22, two inserts 250 can be assembled with the tool 230, one aligned with each pair of opposing posts 236. The inserts 250 can be separate from each other or may be temporarily or permanently coupled (e.g., via the handles 256). Separate inserts 250 can advantageously allow two patties 10 to be cooked and shaped in the system at different times. In other words, one patty 10 and insert 250 could be assembled with the tool 230 and basket 110 to begin cooking and shaping, and then a second patty 10 and insert 250 could be assembled with the tool 230 and basket 110 to begin cooking and shaping at a later time, e.g., while the first patty 10 is still cooking.

Although the example embodiments shown and described herein includes a basket 110 having six troughs 114, the basket 110 could include only two troughs 114—one to align with each of two receptacles 134. Although the example embodiments shown and described herein includes two receptacles 134 and two corresponding wedges 154, the basket 110, tool 130, and insert 150 can be scaled to include more receptacles 134 and corresponding wedges 154 to allow for more patties 10 to be cooked and shaped at once if desired. Although in the example embodiments shown and described herein the basket 110 includes troughs 114 and the insert 150, 250 includes wedges 154, 254, in some embodiments, those features could be reversed such that the basket 110 includes wedges 154 and the insert 150, 250 includes troughs 114. In other words, more generally, while in the illustrated embodiments the basket 110 acts as a female die and the insert 150, 250 acts as a male die, in other embodiments, the basket 110 can include features such that the basket 110 acts as a male die and the insert 150, 250 can include features such that the insert 150 acts as a female die. Furthermore, while the mating or engaging features of the male and female die are described as wedges and troughs in the example embodiments shown and described herein, other mating or engaging features that allow the insert 150, 250 to act as one of the male and female die and the basket 110 to act as the other of the male and female die are also possible. Although the mating features shown and described herein (the wedges 154 and troughs 114) are designed to form a patty 10 into a taco shape, the mating features can have other sizes, shapes, and/or configurations to form a patty 10 or other food item into another desired shape (e.g., a bowl shape).

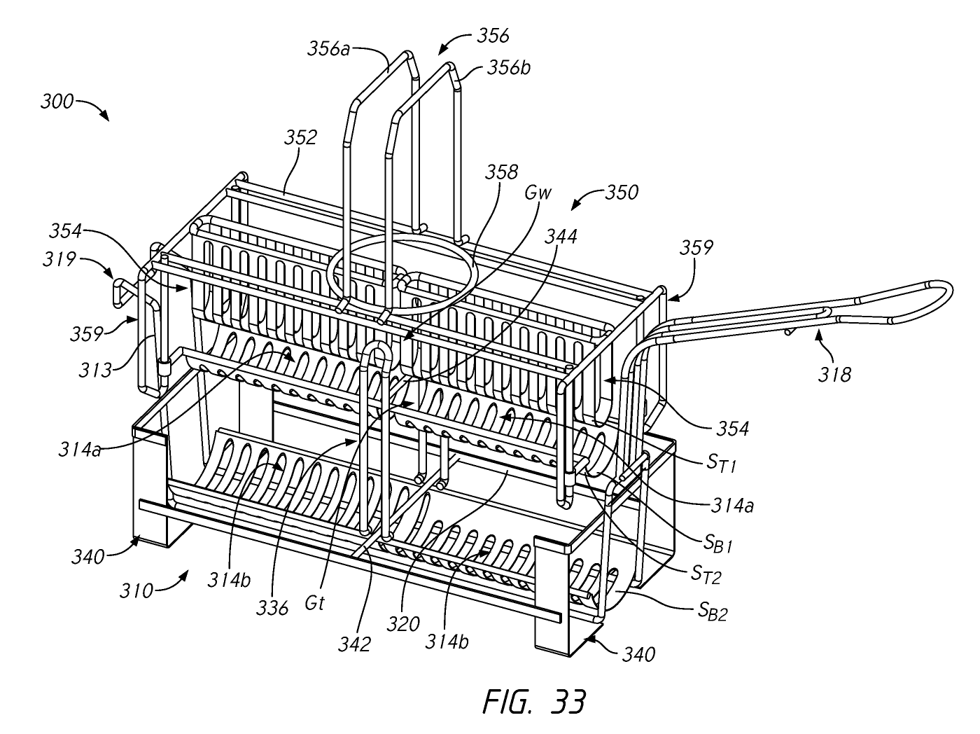

As illustrated in FIGS. 33-35, in some embodiments, a system 300 for shaping a food item, such as the patty 10, includes a basket 310 and an insert 350. An exploded view of another example embodiment of the system 300 for shaping a food item is shown in FIG. 33. The embodiment of the illustrated system 300 is similar to the embodiment of the illustrated system 100 but is configured to shape four patties 10 using upper and lower troughs 314a, 314b. The illustrated system 300 includes two primary components (the basket 310 and the insert 350). The insert 350 of the illustrated system 300 includes a segment 372 that is movable. In certain embodiments, the segment 372 is movable relative to at least another portion of the insert 350.

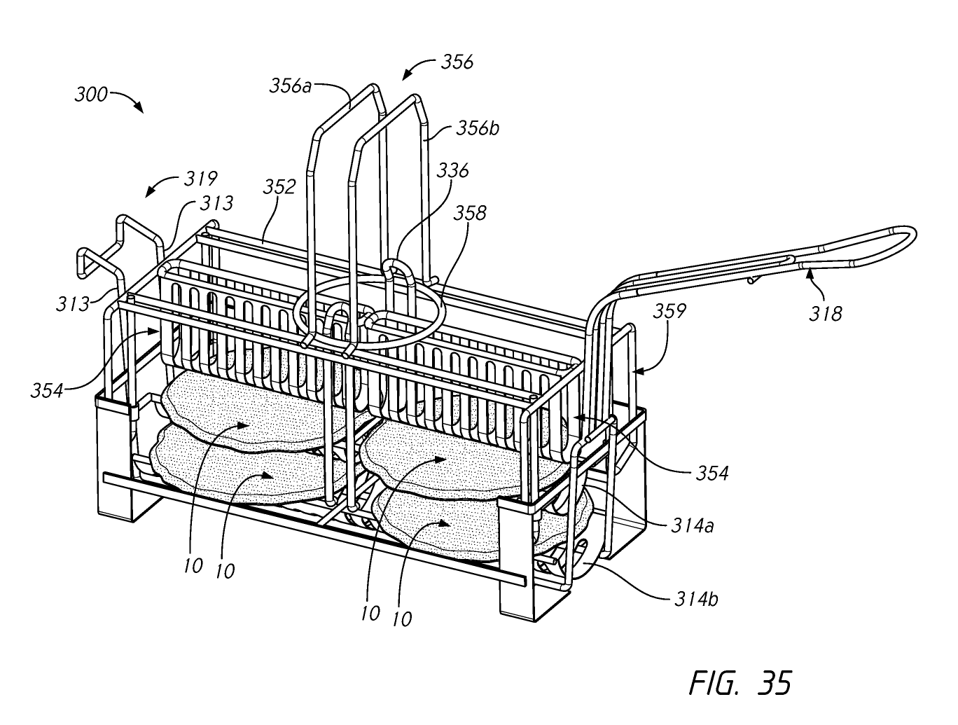

In some embodiments, the system 300 does not include a tool 130. In some embodiments, at least some features of the tool 130 are integrated in the basket 310 and/or the insert 350. In some embodiments, the system 300 is configured to receive and cook more than two patties 10. For example, as shown in FIG. 35, in some embodiments, the system 300 is configured to shape four patties 10. For example, as shown in FIG. 35, in some embodiments, the system 300 is configured to shape both a first patty 10 and second patty 10 that is stacked above the first patty 10.

While two stacks of two patties 10 are illustrated in the system 300, the system 300 is not so limited and could shape more or less than two stacks of patties 10. For example, embodiments of the system 300 can shape one stack of patties 10 or more than two stacks of patties 10. In some embodiments, each stack of patties 10 includes more than two patties 10. In some embodiments, each of the basket 310 and the insert 350 are configured to receive patties 10.

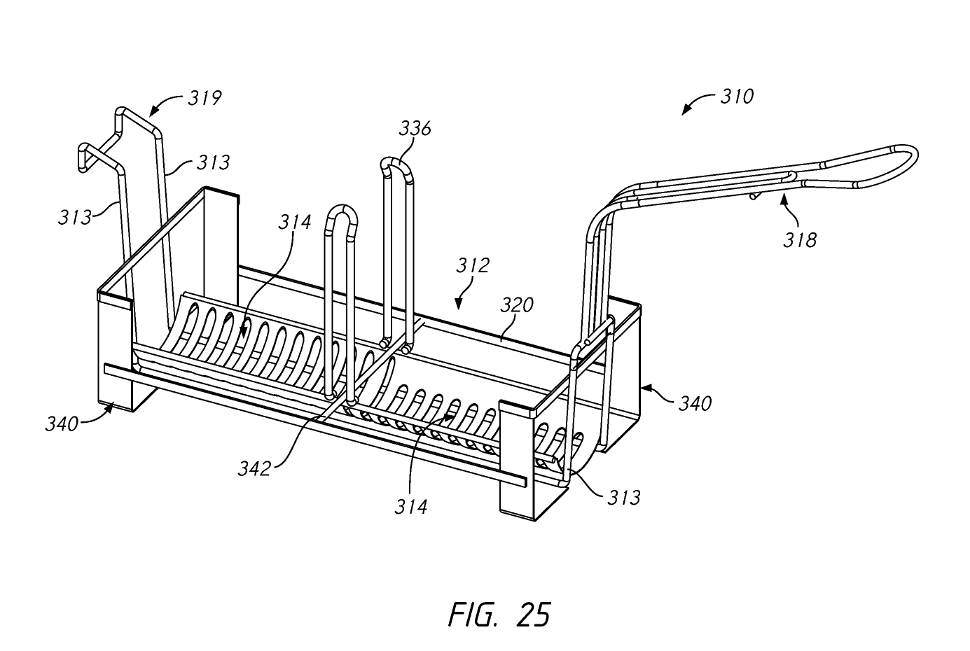

Another example embodiment of the basket 310 is shown in FIGS. 25-28. In some embodiments, the basket 310 includes a base 312 having a frame 320, at least one post 336, and at least one trough 314. The basket 310 can include one or more support bars 313 extending lengthwise along a bottom of the basket 310. In the illustrated embodiment, the basket 310 includes a handle 318 extending from one side or end of the base 312. The basket 310 may include a hook 319 that contacts or engages a fryer during use. In the illustrated embodiment, the hook 319 extends from an opposite end of the base 312 from the handle 318.

As shown in FIG. 25, the at least one trough 314 can extend along the length of the basket 310. The basket 310 can have one continuous trough 314, one trough 314 that is segmented (e.g., separated in the middle), and/or more than one trough 314. In some embodiments, a plane extending along a longitudinal axis of the handle 318 is parallel with a plane extending along a longitudinal axis of the trough 314. The at least one trough 314 of the basket 310 can define the desired shape of the food item or patty 10 (e.g., a curved shell shape). The edges and/or top surface of the at least one trough 314 can be configured to support a food item or frozen patty 10. For example, the edges of the at least one trough 314 can be a shelf for at least one patty 10 prior to cooking and shaping the at least one patty 10.

In some embodiments, the basket 310 can include a channel 340 in each corner of the basket 310. Each channel 340 can define a gap and include a base surface which can advantageously enhance the stability of the basket 310 and the ease of alignment and assembly of the basket 310 with other components.

In some embodiments, the basket 310 can include at least one post 336. As illustrated in FIG. 25, the basket 310 can include two posts 336. The basket 310 can include a cross bar 342 extending between the two posts 336. For example, as shown, the cross bar 342 can extend between lower ends of the posts 336. The cross bar 342 can extend across the width of the basket 310 and connect to lateral sides of the frame 320 of the basket 310.

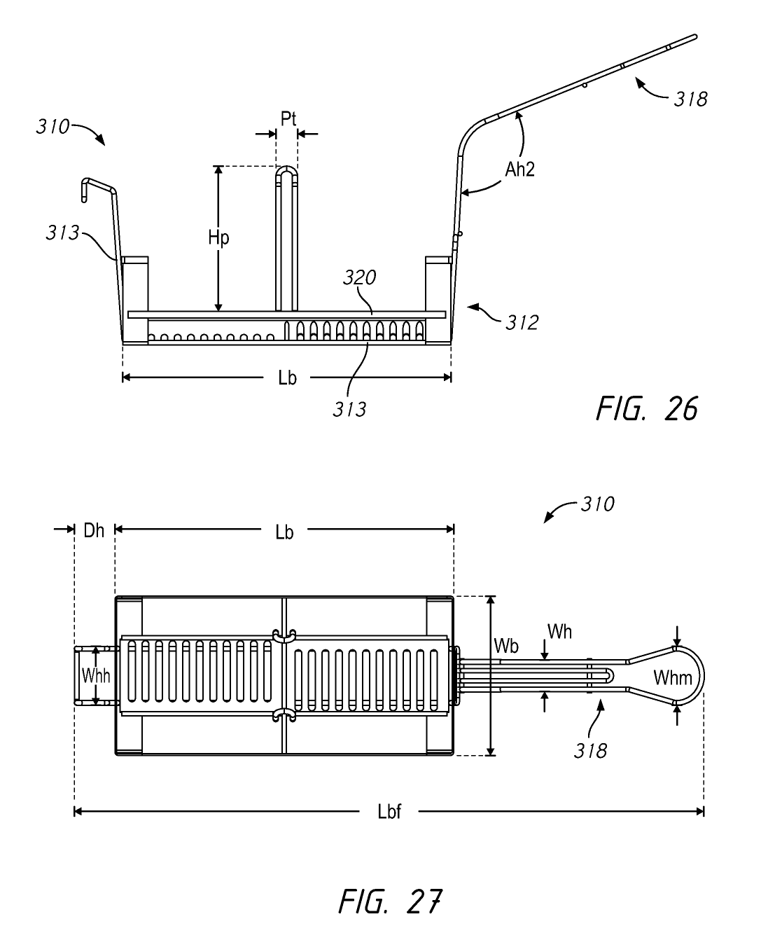

In some embodiments, a length Lb (shown in FIG. 27) of the frame 320 of the basket 310 is about 12¼ to 12⅝ inches and a width Wb of the frame 320 is about 6 inches. In some embodiments, an angle Ah2 (shown in FIG. 26) between an upwardly extending portion of the handle 318 and an outwardly extending portion of the handle 318 can be about 115°.

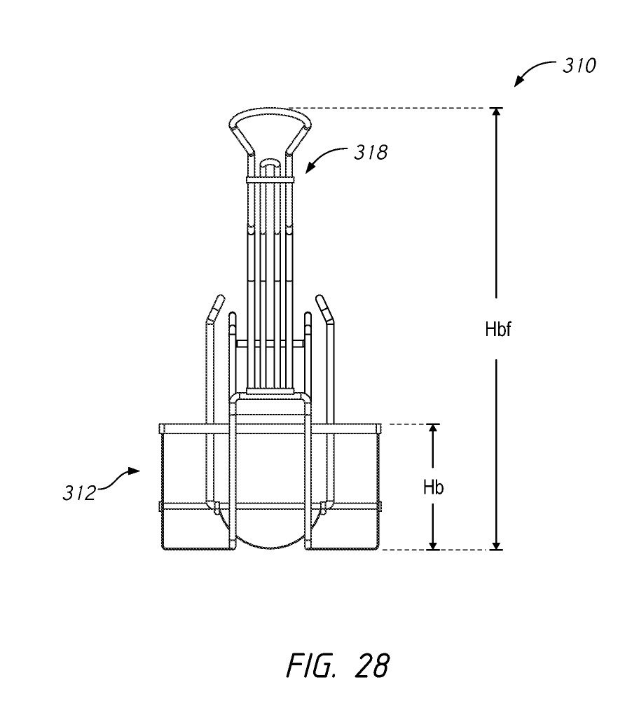

In some embodiments, a body of the handle 318 has a width Wh of about 1¼ inches. An enlarged distal portion of the handle 318 (positioned away from the body 312) may have a width Whm at its widest point of about 1⅞ inches. In some embodiments including the hook 319, the hook 319 may extend a distance Dh of about 1 inch from an end of the frame 320. In some embodiments, the width of the hook 319 Whh (shown in FIG. 27) can be about 2¼ inches. In some embodiments, a full length Lbf of the basket 310 can be about 22½ inches. In some embodiments, a height Hb (shown in FIG. 28) of the base 312 excluding the support bars 313 can be about 3½ inches. A full height Hbf of the basket 310 including the handle 318 and the support bars 313 can be about 9½ inches. In some embodiments, as illustrated in FIGS. 25-28, the posts 336 can be integral with the basket 310. Each post can have a thickness Pt of about ⅞ inch. A height Hp (shown in FIG. 26) of the post 336 can be about 5½ inches.

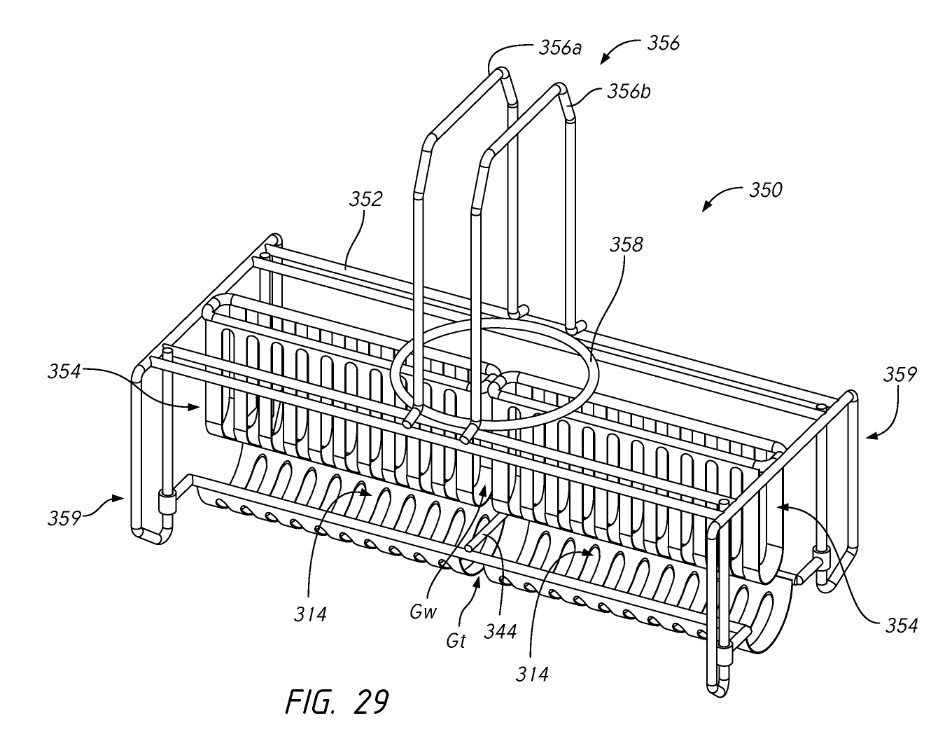

Another example embodiment of the insert 350 is shown in FIGS. 29-32. In some embodiments, the insert 350 includes a frame 352, at least one wedge 354, at least one trough 314, and a handle 356. The at least one wedge 354 can extend downwardly from each end of the frame 352. The handle 356 extends upwardly from or adjacent to lateral sides of the frame 352 in certain embodiments. As shown, the handle 356 can include a first bar 356a and a second bar 356b. The second bar 356b is spaced from the first bar 356a along a length of the insert 350. Each bar 356a, 356b extends across a width of the insert 350. The insert 350 includes a guide 358 positioned between the sides of the frame 352. In the illustrated embodiment, the guide 358 is circular, although other shapes are also possible. In some embodiments, as illustrated in FIG. 29, there is a gap Gw in the at least one wedge 354 of the insert 350 and/or a gap Gt in the at least one trough 314 of the insert 350.

In some embodiments, the at least one trough 314 of the insert 350 is disposed beneath and aligned vertically with the at least one wedge 354. As shown in FIG. 29, the at least one trough 314 can extend along the length of the insert 350. The insert 350 can have a continuous trough 314, a trough 314 that is segmented (e.g., separated in the middle), and/or more than one trough 314. In some embodiments, a plane extending along a longitudinal axis of the at least one wedge 354 is parallel with a plane extending along a longitudinal axis of the at least one trough 314 of the insert 350. The at least one trough 314 of the insert 350 can define the desired shape of the food item or patty 10 (e.g., a curved shell shape). The edges and/or top surface of the at least one trough 314 of the insert 350 can support a food item or frozen patty 10. For example, the edges of the at least one trough 314 of the insert 350 can be a shelf for at least one patty 10 prior to cooking and shaping the patty 10. The at least one trough 314 and the at least one wedge 354 of the insert 350 can be spaced apart, forming a gap defining the desired shape of the patty 10 between the trough 314 and wedge 354. In some embodiments, the insert 350 can include a cross bar 344 extending across a width of the at least one trough 314 of the insert 350.

In some embodiments, as illustrated in FIG. 29, a plurality of side guides 359 can extend downward from opposing ends of the frame 352. The side guides 359 can be located at or adjacent to each corner of the insert 350. The side guides 359 can extend further downward or away from the frame 352 than the at least one wedge 354 and/or the at least one trough 314 of the insert 350.The insert 350 is configured to move relative to the basket 310 in use. In some embodiments, the insert 350 is configured to slidingly engage the basket 310 in use. The insert 350 can include one or more features that can align with one or more corresponding features of the basket 310. For example, in some embodiments, the side guides 359 of the insert 350 can align with and slidingly engage the channels 340 of the basket 310. In some embodiments, the guide 358 of the insert 350 can align with and slidingly engage the posts 336 of the basket 310. In some embodiments, in use, the handle 356 of the insert 350 can guide and/or engage the posts 336 of the basket 310. These features can assist in guiding the components of the system 300 (the insert 350 and the basket 310) together and maintaining the positions of the components relative to one another.

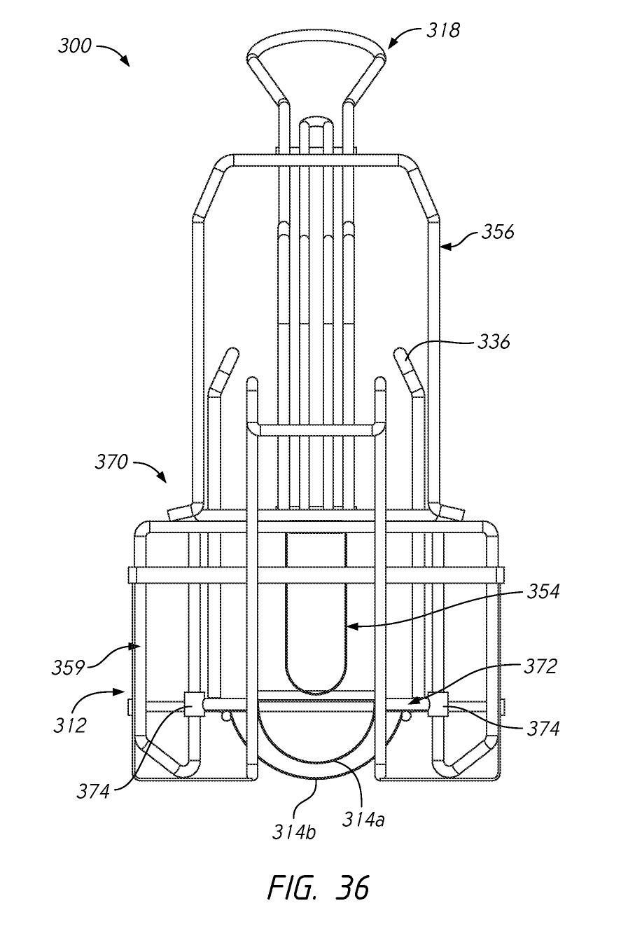

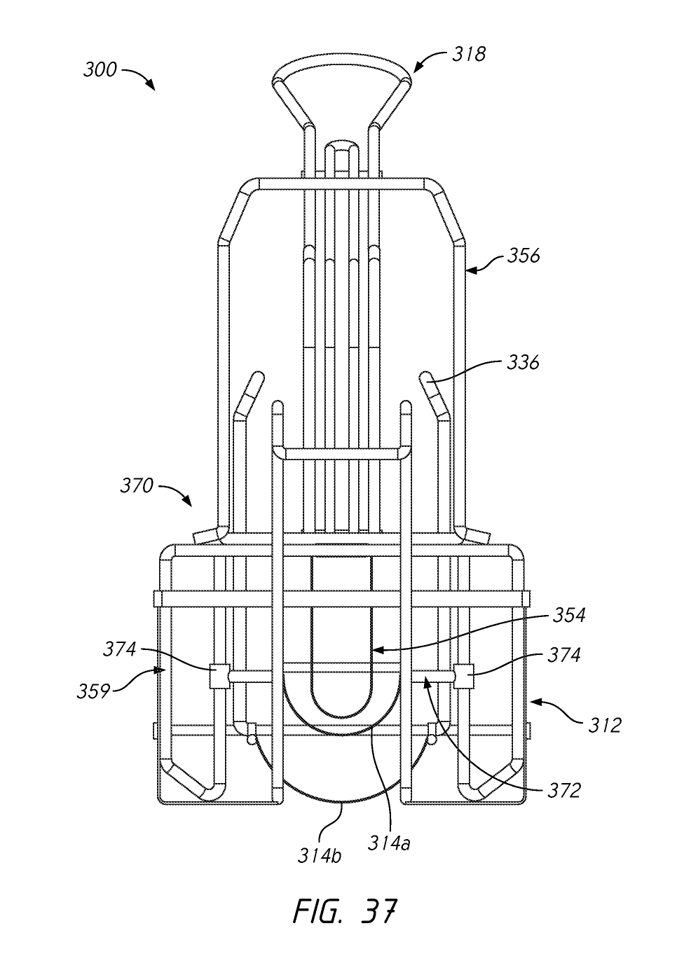

In some embodiments, the entire insert 350 can be movable or slidable relative to the basket. In some embodiments, a movable portion 372 of the insert 350 can be movable or slidable relative to a fixed portion 370 of the insert 350. In some embodiments, the fixed portion 370 of the insert 350 can include the handle 356, the guide 358, the side guides 359, and the at least one wedge 354. In some embodiments, the movable portion 372 of the insert 350 can include the at least one trough 314, the cross bar 344, and a plurality of collars 374. As illustrated in FIGS. 36-37, the movable portion 372 can be slidably engaged to the fixed portion 370 of the insert 350. The collars 374 of the movable portion 372 can be slidably engaged with a plurality of shafts of the fixed portion 370. This allows the relative positions of the wedge 354 and trough 314 to vary.

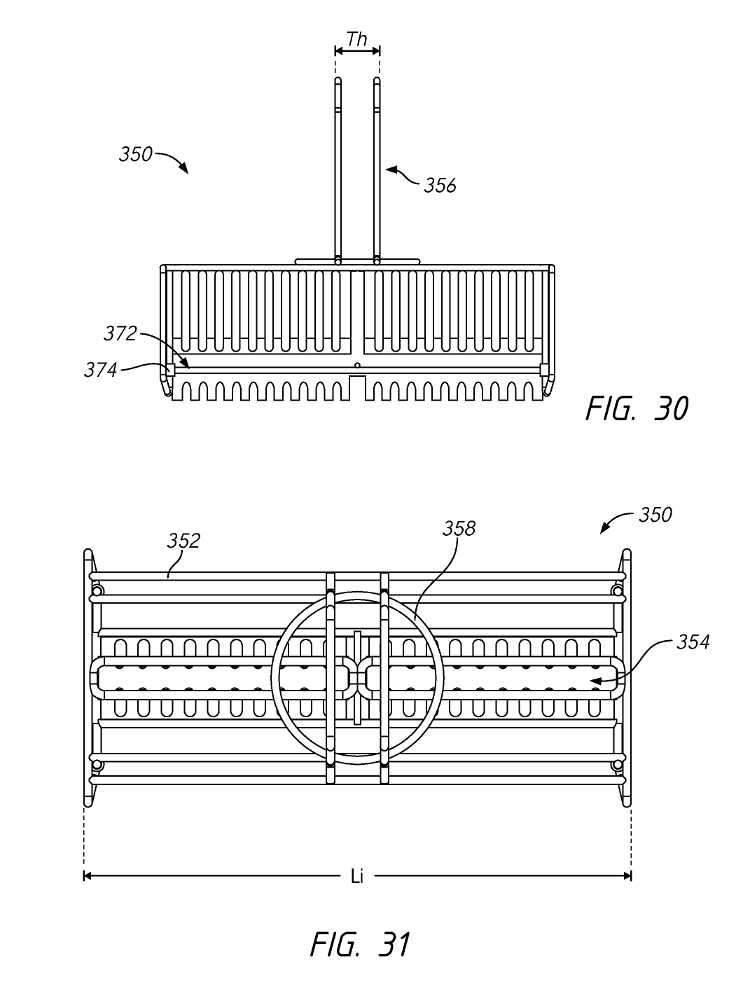

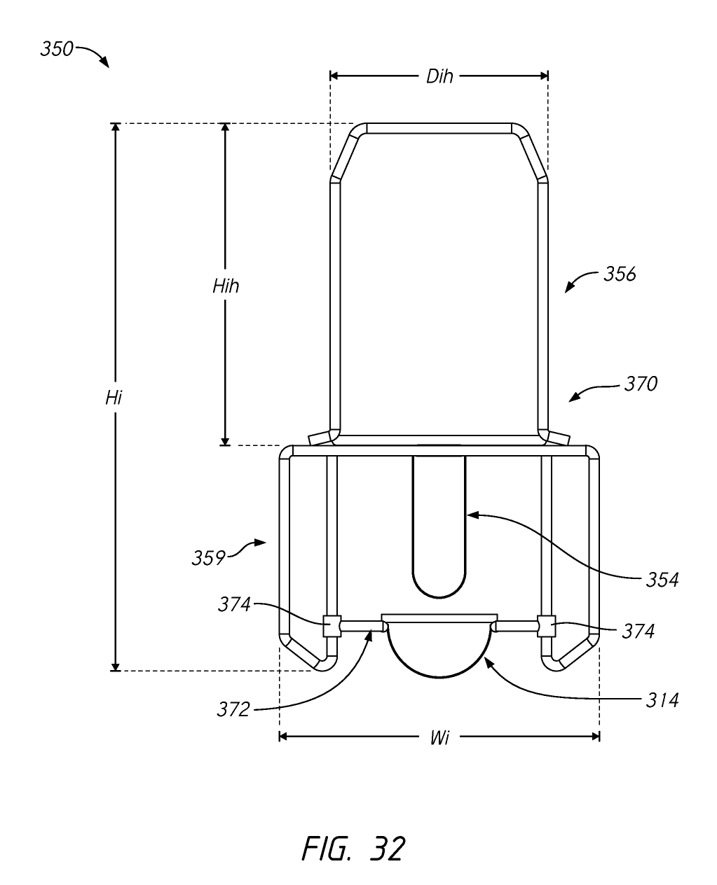

In some embodiments, the insert 350 is sized and shaped to be assembled with the basket 310. In some embodiments, the frame 352 can have a total length Li (shown in FIG. 31) of about 12¼ inches. In some embodiments, the handle 356 can have a thickness measured along the length of the insert 350 Th (shown in FIG. 30) of about 1⅜ inches. In some embodiments, the handle 356 can have a height Hih of about 5⅞ inches. In some embodiments, the handle 356 can span a distance Dih across the width of the insert 350 of about 3¾ inches. In some embodiments, the insert 350 can have a total height Hi (shown in FIG. 32) of about 10 inches. In some embodiments, the insert 350 can have a total width Wi of about 5¾ inches.

In some embodiments, a method for using the system 300 includes loading patties 10 into each of the basket 310 and the insert 350, at positions above the troughs 314 of the basket 310 and the insert 350, respectively. In some embodiments, including the illustrated embodiment, the system 300 has two distinct levels of troughs 314 for retaining the patties 10. In some embodiments, the two distinct levels of troughs 314 are stacked vertically. When the system 300 is assembled, the at least one trough 314 of the insert 350 will be referred to as the at least one upper trough 314a and the at least one trough 314 of the basket 310 will be referred to as the at least one lower trough 314b for ease of explanation. In some embodiments, the system 300 can have more than two distinct levels of troughs 314 for retaining the patties 10 (e.g., three stacked levels). In some embodiments, the shape, curvature, and/or diameter of the troughs 314 can be the same or similar at each level. In some embodiments, including the illustrated embodiment, the shapes or curvatures of the upper and lower troughs 314a, 314b can differ. For example, the curvature of the upper trough 314a can be narrower or wider than the curvature of the lower trough 314b.

In some embodiments, as shown in FIG. 35, the patties 10 can be placed directly in contact with the troughs 314. A patty 10 is placed above the at least one trough 314 of the basket 310 and the at least one trough 314 of the insert 350. The patties 10 may be placed in the system 300 prior to assembling the basket 310 and the insert 350 or after the insert 350 is assembled to the basket 310. In some embodiments, the at least one patty 10 that is placed in the basket 310 rests above the at least one trough 314. In some embodiments, the at least one patty 10 that is placed in the insert 350 rests between the at least one wedge 354 and the at least one trough 314. As discussed above, the patties 10 can be provided frozen such that the patties 10 initially maintain their shape, e.g., round shape. The insert 350 is then guided onto the basket 310. In some embodiments, the guide 358 of the insert 350 aligns with and slides along outer surfaces of the posts 336 of the basket 310 to help properly align the insert 350 relative to the basket 310 as shown in FIG. 35. In some embodiments, as the insert 350 is guided onto the basket 310, the side guides 359 of the insert 350 align with and at least partially engage the channels 340 of the basket 310 to help properly align the insert 350 relative to the basket 310.

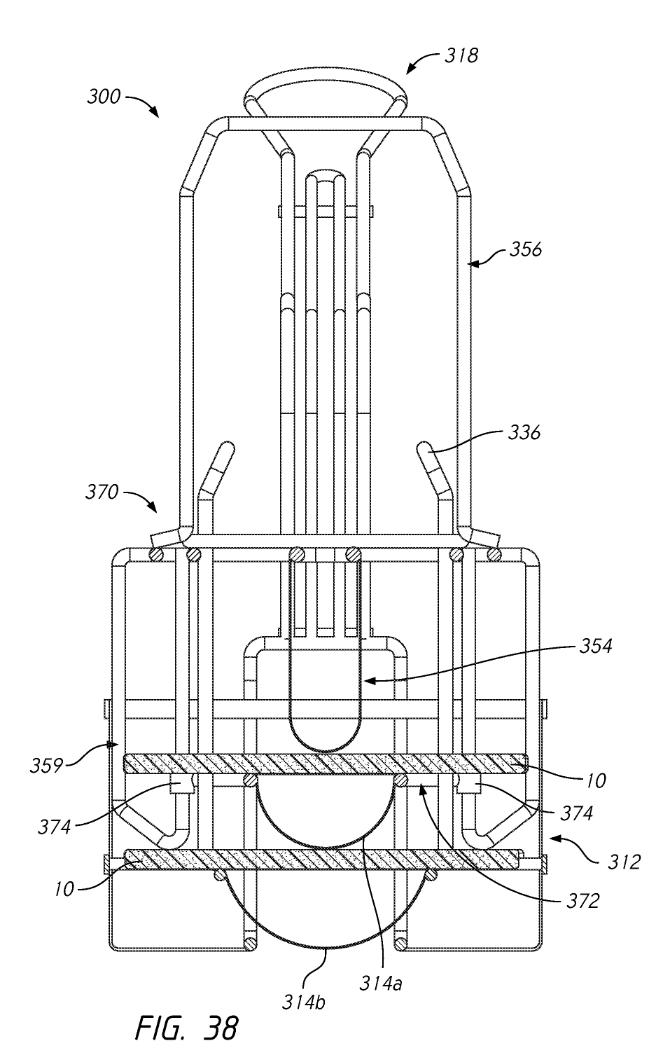

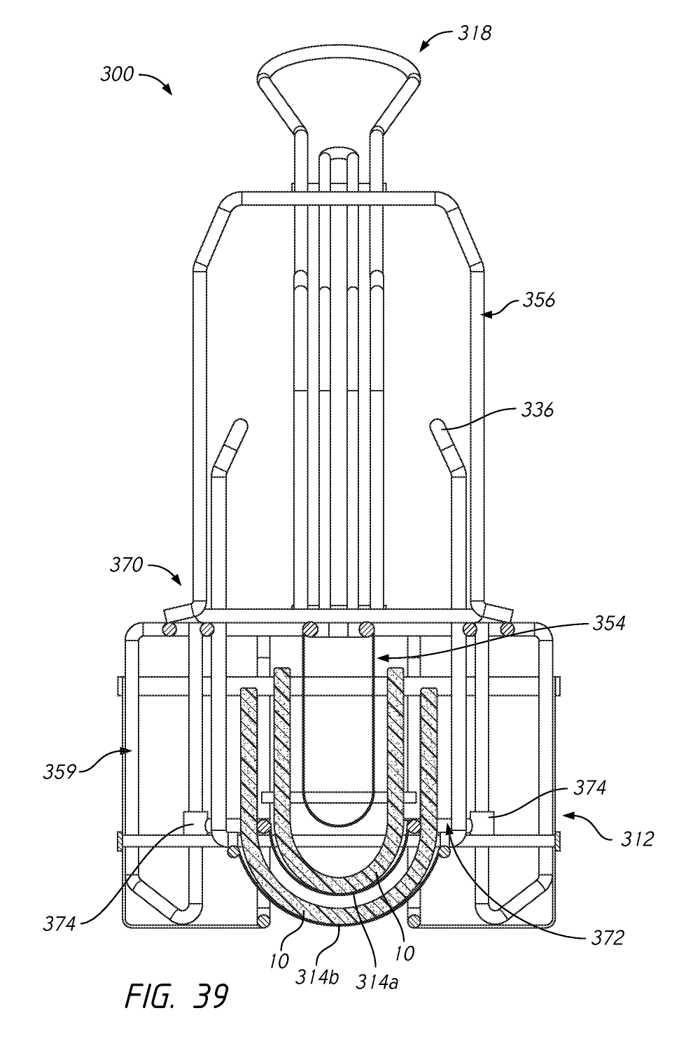

As illustrated in FIGS. 35 and 38-39, the patties 10 can be disposed between the at least one wedge 354 and the upper trough 314a, and between the upper trough 314a and the lower trough 314b. In some embodiments, there is a first gap between the wedge 354 and the upper trough 314a and a second gap between the upper trough 314a and the lower trough 314b. In some embodiments, each of the first and second gaps defines the desired shapes of the patties 10.

In some embodiments, as the insert 350 is advanced downward relative to the basket 310, a bottom surface ST2 of the upper trough 114a will contact a top surface of the at least one patty 10 that was previously placed in the basket 310 (the patty 10 resting above the lower trough 314b). In some embodiments, the contact between the bottom surface ST2 of the upper trough 314a and the top surface of the frozen patty 10 resting above the lower trough 314b prevents the insert 350 (including the movable portion 372 of the insert 350) from advancing downward any further relative to the basket 310 (until the patty 10 has been at least partially cooked and become softer and/or more pliable).

In some embodiments, the assembled basket 310 and insert 350 with patties 10 are placed in a cooking apparatus to cook the patties 10. For example, the assembled basket 310 and insert 350 with patties 10 can be placed in a fryer containing hot oil. Alternatively, the basket 310 and insert 350 with patties 10 can be placed in an oven or microwave. As the patties 10 cook and soften, the weight of the insert 350 causes the wedge 354 and the upper trough 314a to push the patties 10 into the upper trough 314a and the lower trough 314b, respectively. The required or desired rate of the wedge 354 and the upper trough 314 pushing the patties 10 into the upper trough 314a and the lower trough 314b, respectively, and weight of the insert 350, can be selected considering the effect of gravity. The weight of the insert 350 can be selected based on various factors, including, for example, one or more of: the food composition of the patties 10, whether the patties 10 are frozen, the weight of the patties 10, the thickness of the patties 10, and the rigidity of the patties 10.

As the patties 10 cook, the weight of the insert 350 shapes the patties 10 into the desired shape. In some embodiments, the shape is a curved, taco-like shape. In some embodiments, the shape is a circular shape or a rectangular shape.

In some embodiments, as the patties 10 become softer and/or more pliable, the insert 350 and/or the movable portion 372 of the insert 350 advances further downward relative to the basket 310. The upper patty or patties 10 (the patties 10 loaded into the insert 350) are shaped during the cooking process by a bottom surface ST1 of the at least one wedge 254 and a top surface SB1 of the upper trough 314a and/or a gap between the surfaces ST1 and SB1 (shown in FIG. 33). The lower patty or patties 10 (the patties 10 loaded into the basket 310) are shaped during the cooking process by the bottom surface ST2 of the upper trough 314a and a top surface SB2 of the lower trough 314b and/or a gap between the surfaces ST2 and SB2 (shown in FIG. 33).

In some embodiments, the sizes of the gaps between the surfaces ST1 and SB1, and between the surfaces ST2 and SB2, are predefined. In some embodiments, the sizes of these gaps during the cooking process are a function of the properties of the patties 10 (e.g., thickness, composition, desired shape, etc.). As the upper patties 10 are cooked and shaped, the patties 10 at least partially conform to, or hug, the surface SB1. As the lower patties 10 are cooked and shaped, the patties 10 at least partially conform to, or hug, the surface SB2.

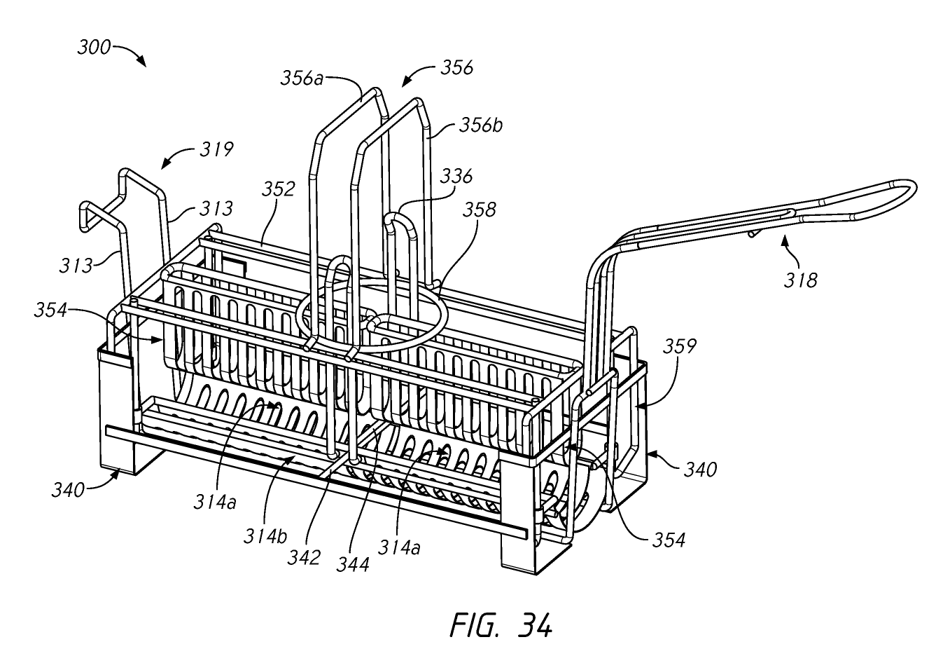

In some embodiments, as shown in FIG. 34, when the assembly 300 is collapsed on itself, the cross bar 344 of the insert 350 abuts the cross bar 142 of the basket 310, limiting movement between the insert 350 and the basket 310.

Once an appropriate cooking time has elapsed in some embodiments, the assembly is removed from the oil, the insert 350 is removed from the basket 310 (before or after removing the assembly from the oil), and the now cooked and shaped patties 10 are removed from the basket 310. In some embodiments, the patties 10 are then placed into curved holders to maintain the curved shapes of the patties 10. The cooked and taco shaped patties 10 can be filled with various fillings.

Although this disclosure has been described in the context of certain embodiments and examples, it will be understood by those skilled in the art that the disclosure extends beyond the specifically disclosed embodiments to other alternative embodiments and/or uses and obvious modifications and equivalents thereof. In addition, while several variations of the embodiments of the disclosure have been shown and described in detail, other modifications, which are within the scope of this disclosure, will be readily apparent to those of skill in the art. It is also contemplated that various combinations or sub-combinations of the specific features and aspects of the embodiments may be made and still fall within the scope of the disclosure. For example, features described above in connection with one embodiment can be used with a different embodiment described herein and the combination still fall within the scope of the disclosure. It should be understood that various features and aspects of the disclosed embodiments can be combined with, or substituted for, one another in order to form varying modes of the embodiments of the disclosure. Thus, it is intended that the scope of the disclosure herein should not be limited by the particular embodiments described above. Accordingly, unless otherwise stated, or unless clearly incompatible, each embodiment of this invention may comprise, additional to its essential features described herein, one or more features as described herein from each other embodiment of the invention disclosed herein.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount. As another example, in certain embodiments, the terms “generally parallel” and “substantially parallel” refer to a value, amount, or characteristic that departs from exactly parallel by less than or equal to 15 degrees, 10 degrees, 5 degrees, 3 degrees, 1 degree, 0.1 degree, or otherwise. Additionally, as used herein, “gradually” has its ordinary meaning (e.g., differs from a non-continuous, such as a step-like, change).

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

What is claimed is:

1. An insert for slidingly engaging with a basket and being movable from a first position to a second position relative to the basket to change a shape of a plurality of food items from a first shape to a second shape during cooking in a fryer, the basket comprising a lower trough, the lower trough defining the second shape, the insert comprising:
a wedge; and
an upper trough disposed below the wedge and defining the second shape, the upper trough being movable in a first direction towards the wedge and in a second direction away from the wedge,
the upper trough of the insert being configured to be disposed above the lower trough of the basket at least when the insert is slidingly engaged with the basket, the upper trough being further configured to move away from the lower trough in the first direction and move towards the lower trough in the second direction when the insert is in the second position.

2. The insert of claim 1, further comprising a plurality of side guides, the upper trough being slidably coupled to the side guides by a plurality of collars.

3. The insert of claim 1, wherein the wedge comprises a first wedge segment, a second wedge segment, and a gap between the first and second wedge segments.

4. The insert of claim 1, wherein the upper trough comprises a first trough segment, a second trough segment, and a gap between the first and second trough segments.

5. The insert of claim 1, further comprising a handle and a guide, the guide being disposed between lateral sides of the handle and configured to slidingly receive a post of the basket when the insert moves to the second position.

6. The insert of claim 1, wherein the first shape is generally planar and at least a portion of the second shape is generally curved.

7. A system for changing a shape of a plurality of food items from a first shape to a second shape during cooking in a fryer, the system comprising:
a basket having a lower trough defining the second shape; and
an insert configured to slidingly engage with the basket and move from a first position to a second position relative to the basket, the insert comprising a wedge and an upper trough disposed below the wedge, the wedge being closer to the lower trough of the basket when the insert is in the second position than when the insert is in the first position, the upper trough defining the second shape and being movable in a first direction towards the wedge and in a second direction towards the lower trough when the insert is in the second position.

8. The system of claim 7, wherein the basket further comprises at least one upwardly extending post and the insert further comprises a guide configured to slidingly receive the at least one post.

9. The system of claim 7, wherein the basket further comprises at least one upwardly extending post and the insert further comprises a handle, the handle of the insert being configured to engage the at least one post of the basket when the insert moves to the second position.

10. The system of claim 7, wherein the insert further comprises a plurality of side guides and a plurality of collars, the upper trough being slidably coupled to the side guides by the collars.

11. The system of claim 10, wherein the wedge is fixed relative to the side guides.

12. The system of claim 7, wherein the wedge comprises a first wedge segment, a second wedge segment, and a gap between the first and second wedge segments.

13. The system of claim 7, wherein the upper trough comprises a first trough segment, a second trough segment, and a gap between the first and second trough segments.

14. The system of claim 7, wherein the insert further comprises a plurality of side guides and the basket further comprises a plurality of channels configured to receive the plurality of side guides when the insert moves to the second position, each of the plurality of channels being disposed in a corner of the basket.

15. The system of claim 7, wherein the second shape of the upper trough is different than the second shape of the lower trough.

16. A method for changing a shape of a plurality of food items from a first shape to a second shape during cooking in a fryer, the method comprising:
providing a basket having a lower trough defining the second shape;
providing an insert having a wedge and an upper trough, the upper trough defining the second shape;
placing one of the plurality of food items in the basket above the lower trough;
placing one of the plurality of food items in the insert between the wedge and the upper trough; and
lowering at least a portion of the basket into the fryer so that the weight of the insert presses the wedge directly against the one of the plurality of food items in the insert and indirectly against the one of the plurality of food items in the basket to form the plurality of food items into the second shape while cooking.

17. The method of claim 16, further comprising lowering the insert into the basket until the upper trough contacts the food item resting above the lower trough.

18. The method of claim 16, further comprising removing the insert and the basket from the fryer and removing the plurality of food items from the insert and the basket.

19. The method of claim 16, further comprising removing the plurality of food items from the fryer and placing the food items into curved containers while the food items are cooling.

20. An apparatus for changing a shape of a first food item and a second food item stacked below the first food item from a first shape to a second shape during cooking in a fryer, the apparatus comprising:
a wedge configured to contact a top surface of the first food item;
a lower trough disposed below the wedge and being movable relative to the wedge, the lower trough having the second shape; and
an upper trough disposed between the wedge and the lower trough and having the second shape, the upper trough being configured to separate the first food item from the second food item and contact a top surface of the second food item when the first food item and the second food item are placed in the apparatus, the upper trough being movable relative to the wedge and the lower trough when the lower trough is a fixed distance from the wedge.
